(19) United States
(12) Patent Application Publication
(10) Pub. No.: US 2024/0273765 A1
(43) Pub. Date: Aug. 15, 2024

(54) VIRTUAL REFERENCE FRAMES FOR IMAGE ENCODING AND DECODING

(71) Applicant: QUALCOMM Incorporated, San Diego, CA (US)

(72) Inventors: Khalid TAHBOUB, San Diego, CA (US); Louis Joseph KEROFSKY, San Diego, CA (US); Scott Benjamin LEASK, San Diego, CA (US); Kai WANG, San Diego, CA (US)

(21) Appl. No.: 18/168,891

(22) Filed: Feb. 14, 2023

(51) Int. Cl. G06T 9/00; G06F 3/14; G06T 3/00; G06T 7/20; G06V 40/16

(52) U.S. Cl. CPC G06T 9/00; G06F 3/14; G06T 3/18; G06T 7/20; G06V 40/161; G06V 40/171; G06T 2207/30201

(57) ABSTRACT

A device includes one or more processors configured to obtain a bitstream corresponding to an encoded version of an image frame. The one or more processors are also configured to, based on determining that the bitstream includes a virtual reference frame usage indicator, generate a virtual reference frame based on synthesis support data included in the bitstream. The one or more processors are further configured to generate a decoded version of the image frame based on the virtual reference frame.

### I. FIELD

The present disclosure is generally related to image encoding and decoding.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive encoded video data corresponding to compressed image frames from another device. Typically, previously decoded image frames are used as reference frames for predicting a decoded image frame. The more suitable such reference frames are for predicting an image frame, the more accurately the image frame can be decoded, resulting in a higher quality reproduction of the video data. However, because the reference frames that are available to conventional decoders are limited to previously decoded image frames, in some circumstances the available references frames are capable of providing only a sub-optimal prediction of an image frame, and thus reduced-quality video reproduction may result. Although decoding quality can be enhanced by transmitting additional data to the decoder to generate a higher-quality reproduction of the image frame, sending such additional data consumes more bandwidth resources that may be unavailable for devices operating with limited transmission channel capacity.

### III. SUMMARY

According to one implementation of the present disclosure, a device includes one or more processors configured to obtain synthesis support data associated with an image frame of a sequence of image frames. The one or more processors are also configured to selectively generate a virtual reference frame based on the synthesis support data. The one or more processors are further configured to generate a bitstream corresponding to an encoded version of the image frame that is at least partially based on the virtual reference frame.

According to another implementation of the present disclosure, a method includes obtaining, at a device, synthesis support data associated with an image frame of a sequence of image frames. The method also includes selectively generating a virtual reference frame based on the synthesis support data. The method further includes generating, at the device, a bitstream corresponding to an encoded version of the image frame that is at least partially based on the virtual reference frame.

According to another implementation of the present disclosure, a non-transitory computer-readable medium stores instructions that, when executed by one or more processors, cause the one or more processors to obtain synthesis support data associated with an image frame of a sequence of image frames. The instructions, when executed by the one or more processors, also cause the one or more processors to selectively generate a virtual reference frame based on the synthesis support data. The instructions, when executed by the one or more processors, further cause the one or more processors to generate a bitstream corresponding to an encoded version of the image frame that is at least partially based on the virtual reference frame.

According to another implementation of the present disclosure, an apparatus includes means for obtaining synthesis support data associated with an image frame of a sequence of image frames. The apparatus also includes means for selectively generating a virtual reference frame based on the synthesis support data. The apparatus further includes means for generating a bitstream corresponding to an encoded version of the image frame that is at least partially based on the virtual reference frame.

According to another implementation of the present disclosure, a device includes one or more processors configured to obtain a bitstream corresponding to an encoded version of an image frame. The one or more processors are also configured to, based on determining that the bitstream includes a virtual reference frame usage indicator, generate a virtual reference frame based on synthesis support data included in the bitstream. The one or more processors are further configured to generate a decoded version of the image frame based on the virtual reference frame.

According to another implementation of the present disclosure, a method includes obtaining, at a device, a bitstream corresponding to an encoded version of an image frame. The method also includes, based on determining that the bitstream includes a virtual reference frame usage indicator, generating a virtual reference frame based on synthesis support data included in the bitstream. The method further includes generating, at the device, a decoded version of the image frame based on the virtual reference frame.

According to another implementation of the present disclosure, a non-transitory computer-readable medium includes instructions that, when executed by one or more processors, cause the one or more processors to obtain a bitstream corresponding to an encoded version of an image frame. The instructions, when executed by the one or more processors, also cause the one or more processors to, based on determining that the bitstream includes a virtual reference frame usage indicator, generate a virtual reference frame based on synthesis support data included in the bitstream. The instructions, when executed by the one or more processors, further cause the one or more processors to generate a decoded version of the image frame based on the virtual reference frame.

According to another implementation of the present disclosure, an apparatus includes means for obtaining a bitstream corresponding to an encoded version of an image frame. The apparatus also includes means for generating a virtual reference frame based on synthesis support data included in the bitstream, the virtual reference frame generated based on determining that the bitstream includes a virtual reference frame usage indicator. The apparatus further includes means for generating a decoded version of the image frame based on the virtual reference frame.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to generate virtual reference frames for image encoding, in accordance with some examples of the present disclosure.

FIG. 2 is a diagram of the system of FIG. 1 operable to generate virtual reference frames for image decoding, in accordance with some examples of the present disclosure.

FIG. 3 is a diagram of an illustrative aspect of operations associated with a frame analyzer and a virtual reference frame generator of FIG. 1, in accordance with some examples of the present disclosure.

FIG. 4 is a diagram of an illustrative aspect of operations associated with a synthesis support analyzer of the frame analyzer of FIG. 1, in accordance with some examples of the present disclosure.

FIG. 5 is a diagram of an illustrative aspect of operations associated with the virtual reference frame generator of FIG. 1, in accordance with some examples of the present disclosure.

FIG. 6 is a diagram of an illustrative aspect of operations associated with a facial virtual reference frame generator of the virtual reference frame generator and a video encoder of FIG. 1, in accordance with some examples of the present disclosure.

FIG. 7 is a diagram of an illustrative aspect of operations associated with a motion virtual reference frame generator of the virtual reference frame generator and the video encoder of FIG. 1, in accordance with some examples of the present disclosure.

FIG. 8 is a diagram of an illustrative aspect of operations associated with a virtual reference frame generator of FIG. 2, in accordance with some examples of the present disclosure.

FIG. 9 is a diagram of an illustrative aspect of operations associated with a facial virtual reference frame generator of the virtual reference frame generator and a video decoder of FIG. 2, in accordance with some examples of the present disclosure.

FIG. 10 is a diagram of an illustrative aspect of operations associated with a motion virtual reference frame generator of the virtual reference frame generator and the video decoder of FIG. 2, in accordance with some examples of the present disclosure.

FIG. 11 is a diagram of an illustrative aspect of operation of the frame analyzer, the virtual reference frame generator, and the video encoder of FIG. 1, in accordance with some examples of the present disclosure.

FIG. 12 is a diagram of an illustrative aspect of operation of the virtual reference frame generator and the video decoder of FIG. 2, in accordance with some examples of the present disclosure.

FIG. 13 illustrates an example of an integrated circuit operable to generate virtual reference frames for image encoding, image decoding, or both, in accordance with some examples of the present disclosure.

FIG. 14 is a diagram of a mobile device operable to generate virtual reference frames for image encoding, image decoding, or both, in accordance with some examples of the present disclosure.

FIG. 15 is a diagram of a wearable electronic device operable to generate virtual reference frames for image encoding, image decoding, or both, in accordance with some examples of the present disclosure.

FIG. 16 is a diagram of a camera operable to generate virtual reference frames for image encoding, image decoding, or both, in accordance with some examples of the present disclosure.

FIG. 17 is a diagram of a headset, such as a virtual reality, mixed reality, or augmented reality headset, operable to generate virtual reference frames for image encoding, image decoding, or both, in accordance with some examples of the present disclosure.

FIG. 18 is a diagram of a first example of a vehicle operable to generate virtual reference frames for image encoding, image decoding, or both, in accordance with some examples of the present disclosure.

FIG. 19 is a diagram of a second example of a vehicle operable to generate virtual reference frames for image encoding, image decoding, or both, in accordance with some examples of the present disclosure.

FIG. 20 is a diagram of a particular implementation of a method of generating virtual reference frames for image encoding that may be performed by the device of FIG. 1, in accordance with some examples of the present disclosure.

FIG. 21 is a diagram of a particular implementation of a method of generating virtual reference frames for image decoding that may be performed by the device of FIG. 2, in accordance with some examples of the present disclosure.

FIG. 22 is a block diagram of a particular illustrative example of a device that is operable to generate virtual reference frames for image encoding, image decoding, or both, in accordance with some examples of the present disclosure.

### V. DETAILED DESCRIPTION

Typically, video decoding includes using previously decoded image frames as reference frames for predicting a decoded image frame. In an example, a sequence of image frames includes a first image frame and a second image frame. An encoder encodes the first image frame to generate first encoded bits. For example, the encoder uses intra-frame compression to generate the first encoded bits.

The encoder encodes the second image frame to generate second encoded bits. For example, the encoder uses a local decoder to decode the first encoded bits to generate a first decoded image frame, and uses the first decoded image frame as a reference frame to encode the second image frame. To illustrate, the encoder determines first residual data based on a difference between the first decoded image frame and the second image frame. The encoder generates second encoded bits based on the first residual data. The first encoded bits and the second encoded bits are transmitted from a first device that includes the encoder to a second device that includes a decoder.

The decoder decodes the first encoded bits to generate a first decoded image frame. For example, the decoder performs intra-frame prediction on the first encoded bits to generate the first decoded image frame. The decoder decodes the second encoded bits to generate residual data of a second decoded image frame. The decoder, in response to determining that the first decoded image frame is a reference frame for the second decoded image frame, generates the second decoded image frame based on a combination of the residual data and the first decoded image frame.

At low bit-rate settings (e.g., used during video conferencing), the presence of compression artifacts can degrade video quality. For example, there may be first compression artifacts associated with the intra-frame compression in the first decoded image frame. As another example, there may be second compression artifacts associated with the decoded residual bits in the second decoded image frame.

Systems and methods of generating virtual reference frames for image encoding and decoding are disclosed. In an example, the encoder determines synthesis support data of the second image frame and generates a virtual reference frame of the second image frame based on the synthesis support data. In some implementations, the synthesis support data can include facial landmark data that indicates locations of facial features in the second image frame. In some implementations, the synthesis support data can include motion-based data indicating global motion (e.g., camera movement) detected in the second image frame relative to the first image frame (or the first decoded image frame generated by the local decoder).

The encoder generates a virtual reference frame based on applying the synthesis support data to the first image frame (or the first decoded image frame). The encoder generates second residual data based on a difference between the virtual reference frame and the second image frame. The encoder generates second encoded bits based on the second residual data. The first encoded bits, the second encoded bits, the synthesis support data, and a virtual reference frame usage indicator are transmitted from the first device to the second device. The virtual reference frame usage indicator indicates virtual reference frame usage.

The decoder decodes the first encoded bits to generate a first decoded image frame. For example, the decoder performs intra-frame prediction on the first encoded bits to generate the first decoded image frame. The decoder decodes the second encoded bits to generate the second residual data. The decoder, in response to determining that the virtual reference frame usage indicator indicates virtual reference frame usage, applies the synthesis support data to the first decoded image frame to generate a virtual reference frame. In an example, the synthesis support data includes facial landmark data indicating locations of facial features in the second image frame. Applying the facial landmark data to the first decoded image frame includes adjusting locations of facial features to more closely match the locations of the facial features indicated in the second image frame. In another example, the synthesis support data includes motion-based data that indicates global motion detected in the second image frame relative to the first image frame. Applying the motion-based data to the first decoded image frame includes applying the global motion to the first decoded image frame to generate the virtual reference frame. The decoder applies the second residual data to the virtual reference frame to generate a second decoded image frame.

Using the virtual reference frame can improve video quality by retaining perceptually important features (e.g., facial landmarks) in the second decoded image frame. In some examples, the synthesis support data and an encoded version of the second residual data (e.g., corresponding to the difference between the virtual reference frame and the second image frame) use fewer bits than an encoded version of the first residual data (e.g., corresponding to the difference between the first decoded image frame and the second image frame). To illustrate, the second residual data can have smaller numerical values, and less variance overall, as compared to the first residual data, so the second residual data can be encoded more efficiently (e.g., using fewer bits). In these examples, the virtual reference frame approach can reduce bandwidth usage, improve video quality, or both.

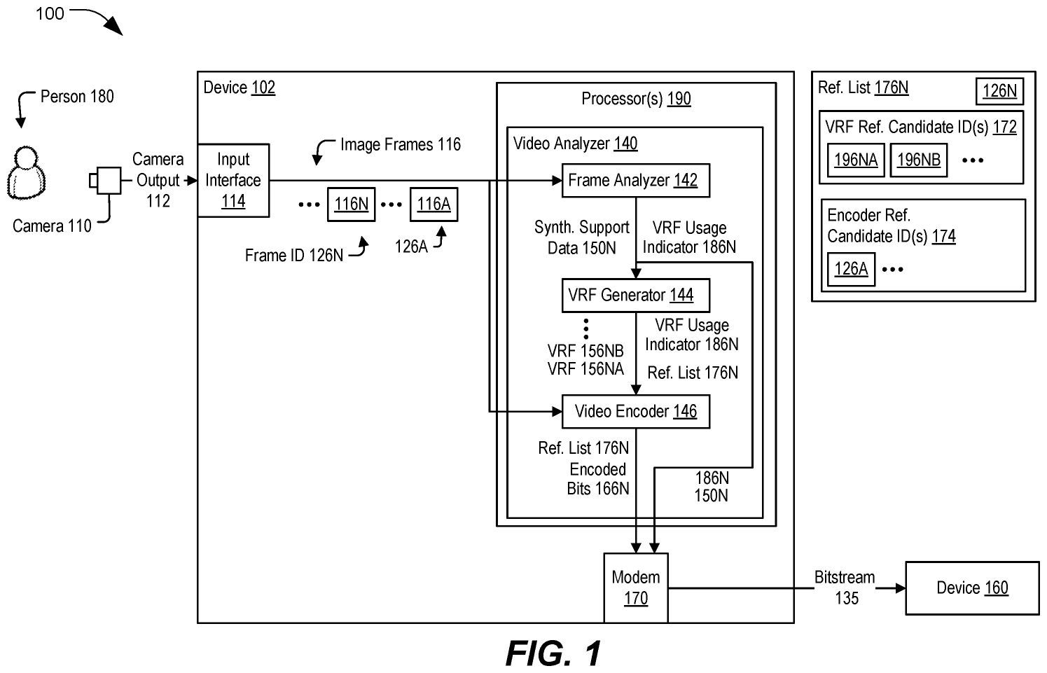

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple image frames are illustrated and associated with reference numbers 116A and 116N. When referring to a particular one of these image, such as an image frame 116A, the distinguishing letter “A” is used. However, when referring to any arbitrary one of these image frames or to these image frames as a group, the reference number 116 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 is shown that is configured to generate virtual reference frames for image encoding and decoding. The system 100 includes a device 102 that is configured to be coupled to a camera 110, a device 160, or both.

The device 102 includes an input interface 114, one or more processors 190, and a modem 170. The input interface 114 is coupled to the one or more processors 190 and configured to be coupled to the camera 110. The input interface 114 is configured to receive a camera output 112 from the camera 110 and to provide the camera output 112 to the one or more processors 190 as image frames 116.

The one or more processors 190 are coupled to the modem 170 and include a video analyzer 140. The video analyzer 140 includes a frame analyzer 142 coupled, via a virtual reference frame (VRF) generator 144, to a video encoder 146. The video encoder 146 is coupled to the modem 170.

The video analyzer 140 is configured to obtain a sequence of image frames 116, such as an image frame 116A, an image frame 116N, one or more additional image frames, or a combination thereof. In some implementations, the sequence of image frames 116 can include one or more image frames prior to the image frame 116A, one or more image frames between the image frame 116A and the image frame 116N, one or more image frames subsequent to the image frame 116N, or a combination thereof.

Each of the image frames 116 is associated with a frame identifier (ID) 126. For example, the image frame 116A has a frame identifier 126A, the image frame 116N has a frame identifier 126N, and so on. In some implementations, the frame identifiers 126 indicate an order of the image frames 116 in the sequence. In an example, the frame identifier 126A having a first value that is less than a second value of the frame identifier 126N indicates that the image frame 116A is prior to the image frame 116N in the sequence.

The video analyzer 140 is configured to selectively generate one or more virtual reference frames (VRFs) for particular ones of the image frames 116. The frame analyzer 142 is configured to, in response to determining that at least one VRF 156 associated with an image frame 116N is to be generated, generate synthesis support data 150N of the image frame 116N. The synthesis support data 150N can include facial landmark data, motion-based data, or both. For example, the frame analyzer 142 is configured to, in response to detecting a face in the image frame 116N, generate facial landmark data as the synthesis support data 150N. The facial landmark data indicates locations of facial features detected in the image frame 116N. As another example, the frame analyzer 142 is configured to, in response to determining that motion-based data indicates global motion in the image frame 116N relative to the image frame 116A (e.g., a previous image frame in the sequence) is greater than a global motion threshold, include the motion-based data in the synthesis support data 150N.

In an example, the frame analyzer 142 is configured to, in response to determining that no VRFs are to be generated for an image frame 116N, generate a virtual reference frame (VRF) usage indicator 186N having a first value (e.g., 0). For example, the frame analyzer 142 is configured to, in response to determining that a face is not detected in the image frame 116N and that global motion less than or equal to a global motion threshold is detected in the image frame 116N, determine that no VRFs are to be generated for the image frame 116N. Alternatively, the frame analyzer 142 is configured to, in response to determining that at least one VRF 156N is to be generated for an image frame 116N, generate a VRF usage indicator 186N having a second value (e.g., 1), a third value (e.g., 2), or a fourth value (e.g., 3). For example, the VRF usage indicator 186N has the second value (e.g., 1) to indicate that the synthesis support data 150N includes facial landmark data, the third value (e.g., 2) to indicate that the synthesis support data 150N includes motion-based data, or the fourth value (e.g., 3) to indicate that the synthesis support data 150N includes both the facial landmark data and the motion-based data.

The VRF generator 144 is configured to, in response to determining that the VRF usage indicator 186N has a value (e.g., 1, 2, or 3) indicating VRF usage for the image frame 116N, generate one or more VRFs 156N based on the synthesis support data 150N. A reference list 176 associated with an image frame 116 indicates reference frame candidates for the image frame 116. In an example, the VRF generator 144 is configured to generate a reference list 176N associated with the image frame 116N that indicates the one or more VRFs 156N. The video encoder 146 is configured to encode the image frame 116N based on the reference frame candidates indicated by the reference list 176N to generate encoded bits 166N.

The modem 170 is coupled to the one or more processors 190 and is configured to enable communication with the device 160, such as to send a bitstream 135 via wireless transmission to the device 160. For example, the bitstream 135 includes the reference list 176N, the encoded bits 166N, the synthesis support data 150N, the VRF usage indicator 186N, or a combination thereof.

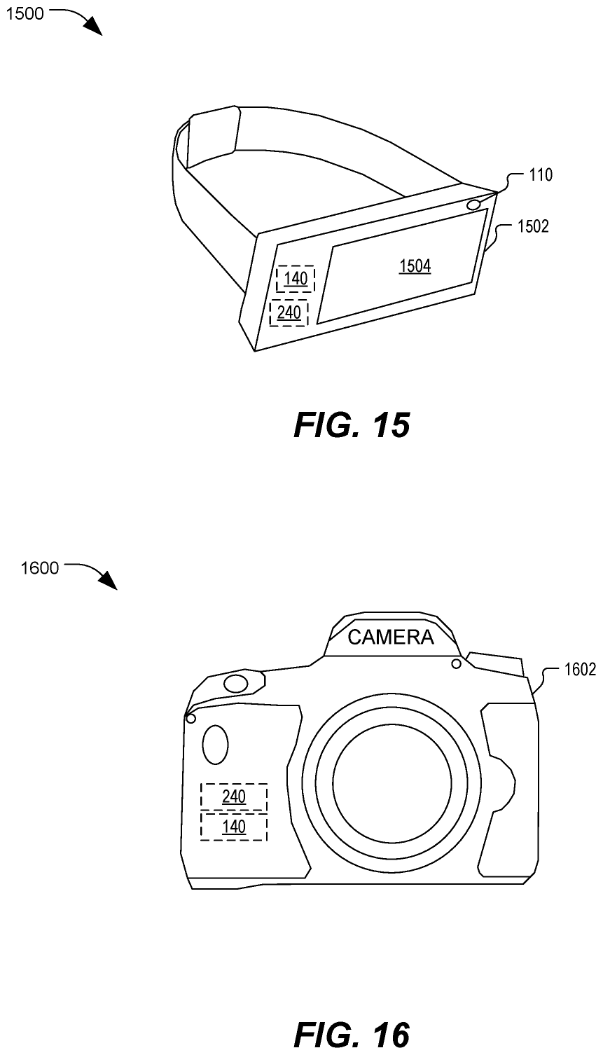

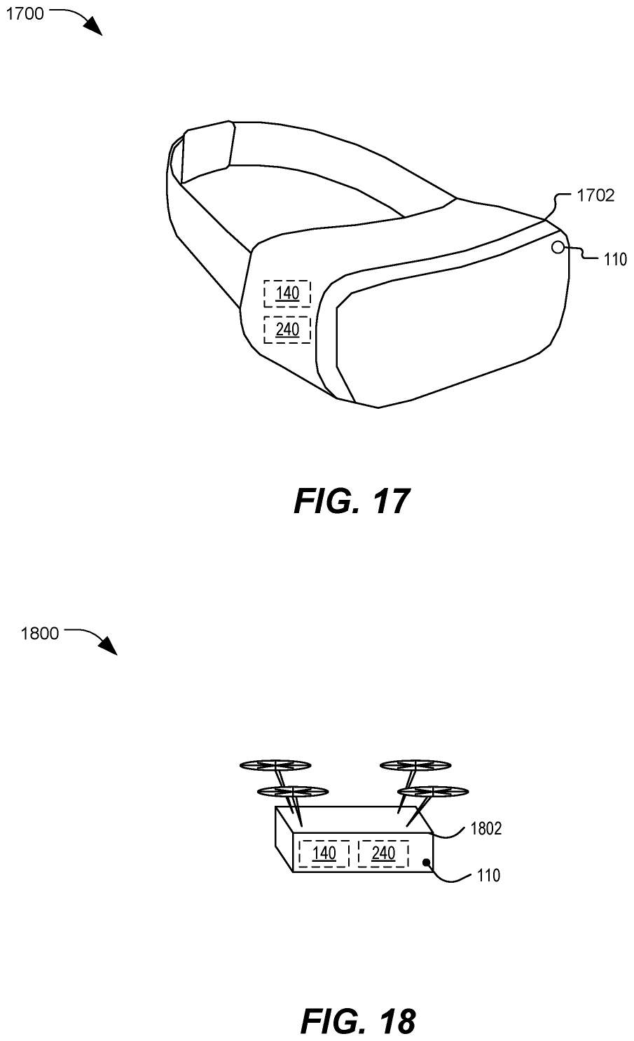

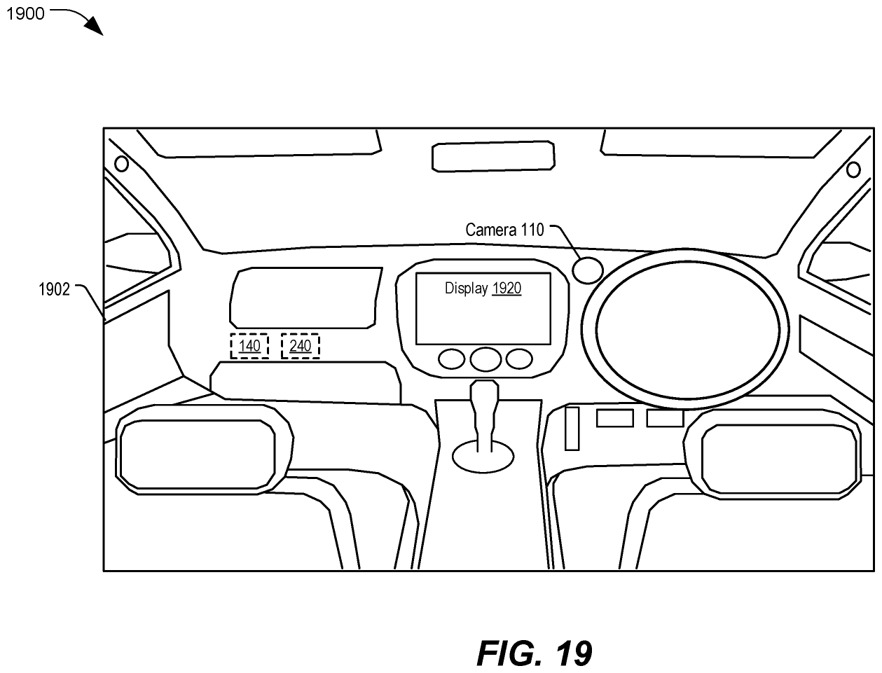

In some implementations, the device 102 corresponds to or is included in one of various types of devices. In an illustrative example, the one or more processors 190 are integrated in at least one of a mobile phone or a tablet computer device, as described with reference to FIG. 14, a wearable electronic device, as described with reference to FIG. 15, a camera device, as described with reference to FIG. 16, or a virtual reality, mixed reality, or augmented reality headset, as described with reference to FIG. 17. In another illustrative example, the one or more processors 190 are integrated into a vehicle, such as described further with reference to FIG. 18 and FIG. 19.

During operation, the video analyzer 140 obtains a sequence of image frames 116. In a particular example, the input interface 114 receives a camera output 112 from the camera 110 and provides the camera output 112 as the image frames 116 to the video analyzer 140. In another example, the video analyzer 140 obtains the image frames 116 from a storage device, a network device, another component of the device 102, or a combination thereof.

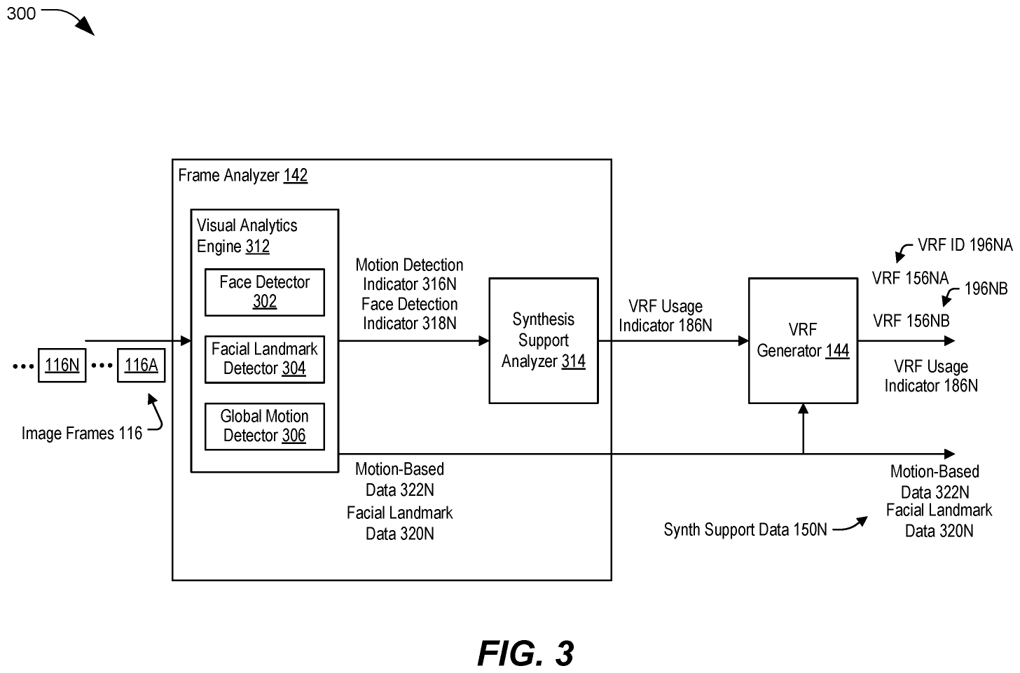

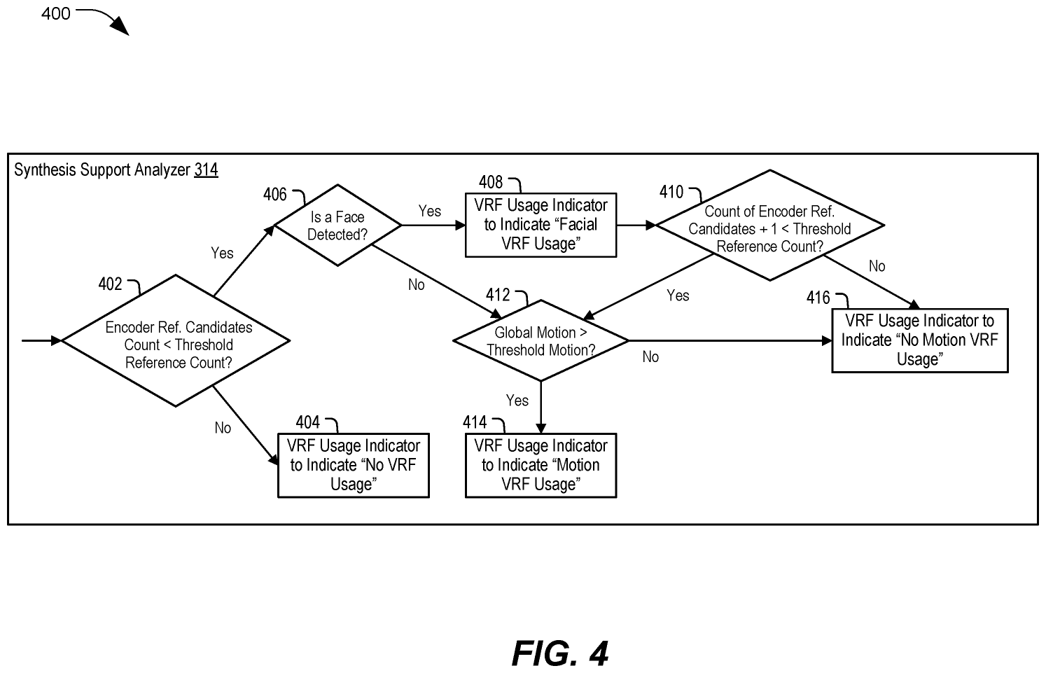

The video analyzer 140 selectively generates VRFs for the image frames 116. In an example, the frame analyzer 142 generates synthesis support data 150N, a VRF usage indicator 186N, or both, based on determining whether at least one VRF is to be generated for the image frame 116N, as further described with reference to FIGS. 3 and 4. For example, the frame analyzer 142, in response to determining that no VRF is to be generated for the image frame 116N, generates a VRF usage indicator 186N having a first value (e.g., 0) indicating no VRF usage. Alternatively, the frame analyzer 142, in response to determining that at least a face of a person 180 is detected in the image frame 116N, adds the facial landmark data to the synthesis support data 150N and generates the VRF usage indicator 186N having a second value (e.g., 1) indicating facial VRF usage. The facial landmark data indicates locations of facial features of the person 180 detected in the image frame 116N. According to some aspects, the facial features include at least one of an eye, an eyelid, an eyebrow, a nose, lips, or a facial outline of the person 180.

In yet another example, the frame analyzer 142 generates motion-based data based on a comparison of the image frame 116N and the image frame 116A (e.g., a previous image frame in the sequence). In some implementations, the motion-based data includes motion sensor data indicating motion of an image capture device (e.g., the camera 110) associated with the image frame 116N. In some implementations, the motion-based data indicates a global motion detected in the image frame 116N relative to a previous image frame (e.g., the image frame 116A).

The frame analyzer 142, in response to determining that the motion-based data indicates global motion that is greater than a global motion threshold, adds the motion-based data to the synthesis support data 150N and generates the VRF usage indicator 186N having a third value (e.g., 2) indicating motion VRF usage. In some examples, the frame analyzer 142, in response to determining that motion-based data and facial landmark data are to be used to generate at least one VRF, generates the synthesis support data 150N including the facial landmark data and the motion-based data, and generates the VRF usage indicator 186N having a fourth value (e.g., 3) indicating both facial VRF usage and motion VRF usage. The frame analyzer 142 provides the VRF usage indicator 186N to the VRF generator 144. In examples in which the VRF usage indicator 186N has a value (e.g., 1, 2, or 3) indicating VRF usage, the frame analyzer 142 provides the synthesis support data 150N to the VRF generator 144. In a particular aspect, the synthesis support data 150N, the VRF usage indicator 186N, or both, include the frame identifier 126N to indicate an association with the image frame 116N.

The VRF generator 144, responsive to determining that the VRF usage indicator 186N has the first value (e.g., 0) indicating that no VRF usage, provides the VRF usage indicator 186N to the video encoder 146 and refrains from passing a reference list 176N to the video encoder 146. Optionally, in some implementations, the VRF generator 144, in response to determining that the VRF usage indicator 186N has the first value (e.g., 0) indicating no VRF usage, passes an empty list as the reference list 176N to the video encoder 146.

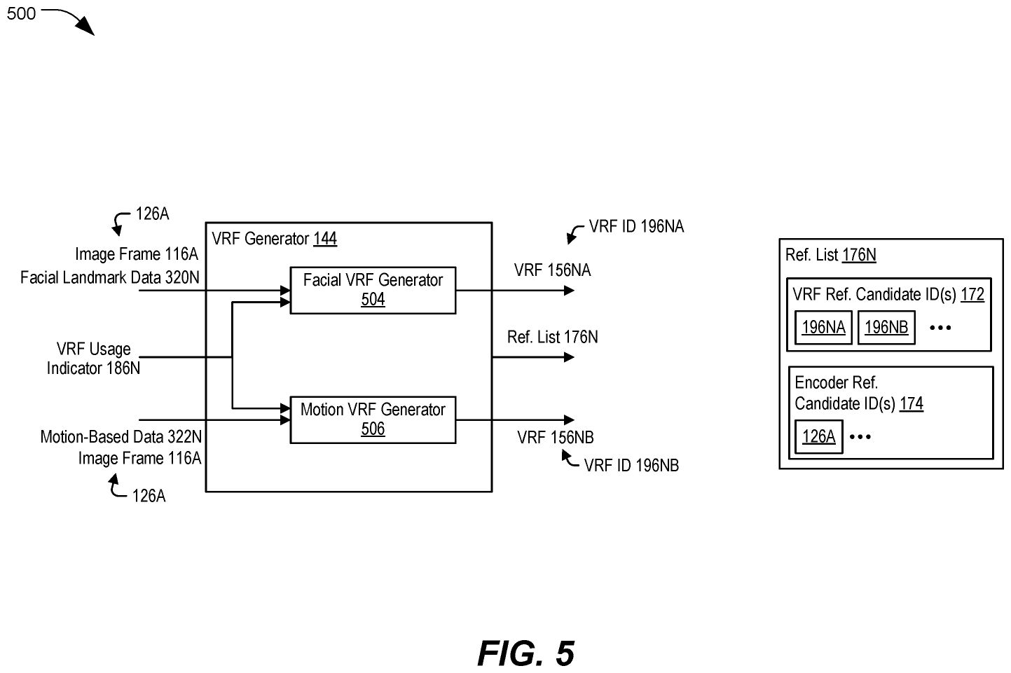

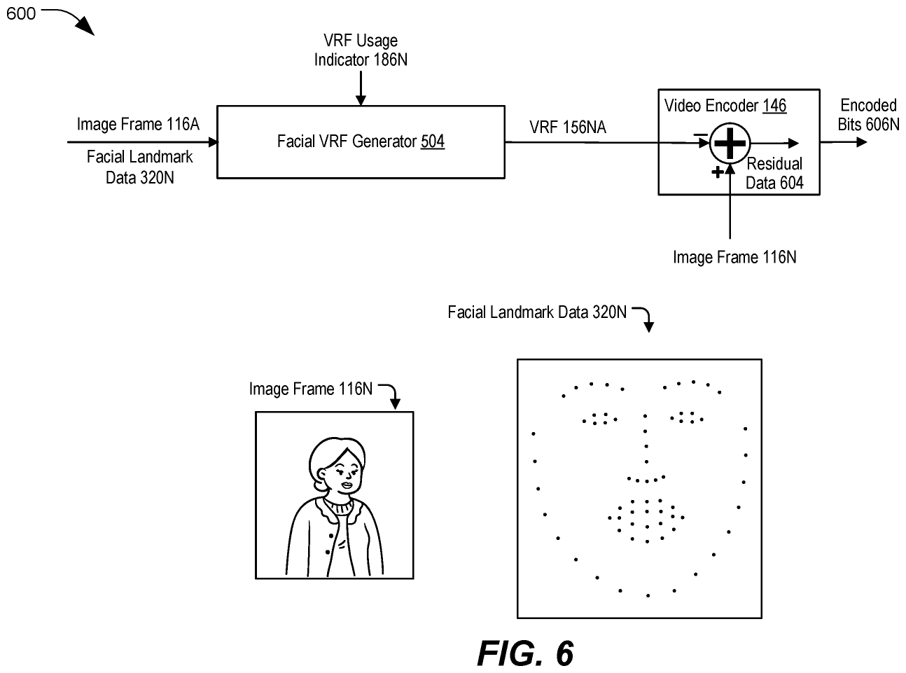

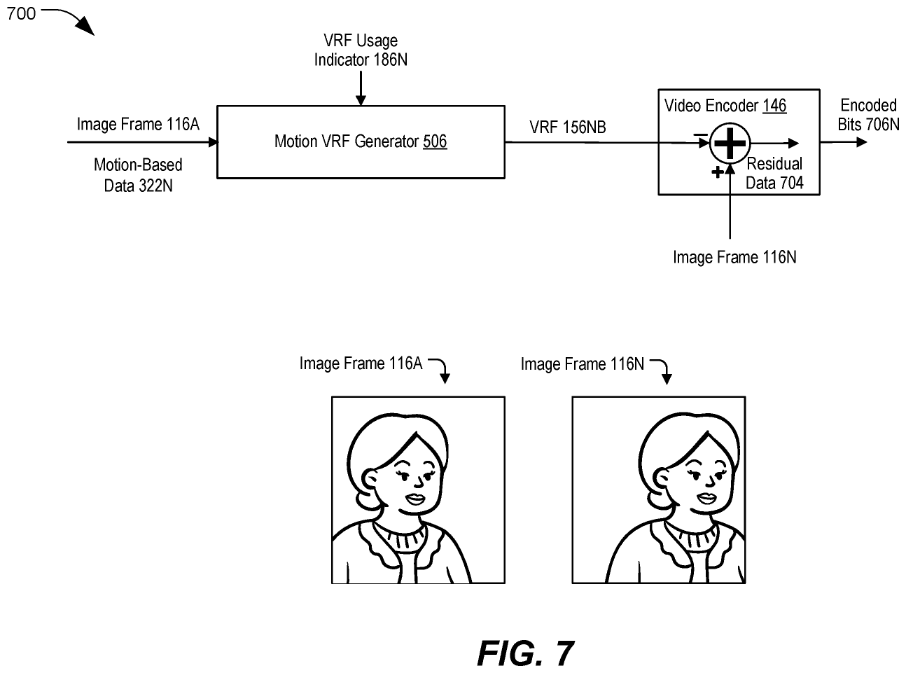

Alternatively, the VRF generator 144, in response to determining that the VRF usage indicator 186N has a value (e.g., 1, 2, or 3) indicating that VRF usage, generates one or more VRFs 156N as one or more VRF reference candidates associated with the image frame 116N. For example, the VRF generator 144, responsive to determining that the VRF usage indicator 186N has a value (e.g., 1 or 3) indicating facial VRF usage, generates at least a VRF 156NA based on the facial landmark data included in the synthesis support data 150N, as further described with reference to FIGS. 5 and 6. The VRF generator 144, responsive to determining that the VRF usage indicator 186N has a value (e.g., 2 or 3) indicating motion VRF usage, generates at least a VRF 156NB based on the motion-based data included in the synthesis support data 150N, as further described with reference to FIGS. 5 and 7.

The VRF generator 144 generates a reference list 176N to indicate that the one or more VRFs 156N are designated as a first set of reference candidates (e.g., VRF reference candidates) for the image frame 116N. In an example, the reference list 176N includes the frame identifier 126N to indicate an association with the image frame 116N. The reference list 176N includes one or more VRF reference candidate identifiers 172 of the first set of reference candidates. For example, the one or more VRF reference candidate identifiers 172 include one or more VRF identifiers 196N of the one or more VRFs 156N. To illustrate, the one or more VRF reference candidate identifiers 172 include a VRF identifier 196NA of the VRF 156NA, a VRF identifier 196NB of the VRF 156NB, one or more additional VRF identifiers of one or more additional VRFs, or a combination thereof. The VRF generator 144 provides the one or more VRFs 156N, the reference list 176N, the VRF usage indicator 186N, or a combination thereof to the video encoder 146.

The video encoder 146 is configured to encode the image frame 116N to generate encoded bits 166N. In a particular aspect, the video encoder 146 generates a subset of the encoded bits 166N based at least in part on a second set of reference candidates (e.g., encoder reference candidates) that are distinct from the VRFs 156. The second set of reference candidates includes one or more previous image frames or one or more previously decoded image frames. In a particular implementation, the video encoder 146 uses the image frame 116A (or a locally decoded image frame corresponding to the image frame 116A) as an intra-coded frame (i-frame). In this implementation, the subset of the encoded bits 166N is based on a residual corresponding to a difference between the image frame 116A (or the locally decoded image frame) and the image frame 116N. The video encoder 146 adds the frame identifier 126A of the image frame 116A (or the locally decoded image frame) to one or more encoder reference candidate identifiers 174 of the second set of reference candidates in the reference list 176N.

The video encoder 146 selectively generates one or more subsets of the encoded bits 166N based on the one or more VRFs 156N. For example, the video encoder 146, in response to determining that the VRF usage indicator 186N has a particular value (e.g., 1, 2, or 3) indicating VRF usage and that an encoder reference candidates count is less than a threshold reference count, generates one or more subsets of the encoded bits 166N based on the one or more VRFs 156N. Alternatively, the video encoder 146, in response to determining that the VRF usage indicator 186N has a particular value (e.g., 0) indicating no VRF usage, that the encoder reference candidates count is greater than or equal to the threshold reference count, or both, refrains from generating any of the encoded bits 166N based on a VRF 156.

In a particular aspect, the video encoder 146 determines the encoder reference candidates count based on a count of the one or more encoder reference candidate identifiers 174 included in the reference list 176N. In some aspects, the encoder reference candidates count is based on default data, a configuration setting, a user input, a coding configuration of the video encoder 146, or a combination thereof. In some implementations, the threshold reference count is based on default data, a configuration setting, a user input, a coding configuration of the video encoder 146, or a combination thereof.

Optionally, in some implementations, the VRF generator 144 selectively generates the one or more VRFs 156N based on determining that the encoder reference candidates count is less than the threshold reference count. In a particular aspect, the VRF generator 144 determines the encoder reference candidates count based on default data, a configuration setting, a user input, a coding configuration of the video encoder 146, or a combination thereof. In a particular aspect, the VRF generator 144 receives the encoder reference candidates count from the video encoder 146.

In some implementations, the VRF generator 144 determines a threshold VRF count based on a comparison of (e.g., a difference between) the threshold reference count and the encoder reference candidates count. In these implementations, the VRF generator 144 generates the one or more VRFs 156N such that a count of the one or more VRFs 156N is less than or equal to the threshold VRF count.

In a particular aspect, the video encoder 146, based at least in part on determining that the VRF usage indicator 186N has a particular value (e.g., 1 or 3) indicating facial VRF usage, generates a first subset of the encoded bits 166N based on the VRF 156NA, as further described with reference to FIG. 6. The video encoder 146, based at least in part on determining that the VRF usage indicator 186N has a particular value (e.g., 2 or 3) indicating motion VRF usage, generates a second subset of the encoded bits 166N based on the VRF 156NB, as further described with reference to FIG. 7.

The video encoder 146 provides the reference list 176N, the encoded bits 166N, or both, to the modem 170. Additionally, the frame analyzer 142 provides the VRF usage indicator 186N, the synthesis support data 150N, or both, to the modem 170. The modem 170 transmits a bitstream 135 to the device 160. The bitstream 135 includes the encoded bits 166N, the reference list 176N, the VRF usage indicator 186N, the synthesis support data 150N, or a combination thereof. For example, the VRF usage indicator 186N indicates whether any virtual reference frames are to be used to generate a decoded version of the image frame 116N.

In some aspects, the bitstream 135 includes a supplemental enhancement information (SEI) message indicating the synthesis support data 150N. In some aspects, the bitstream 135 includes a SEI message including the VRF usage indicator 186N. In a particular aspect, the bitstream 135 corresponds to an encoded version of the image frame 116N that is at least partially based on the one or more VRFs 156N, one or more encoder reference candidates associated with the one or more encoder reference candidate identifiers 174, or a combination thereof.

In some implementations, the bitstream 135 includes encoded bits 166, reference lists 176, VRF usage indicators 186, synthesis support data 150, or a combination thereof, associated with a plurality of the image frames 116. In a particular implementation, the bitstream 135 includes a reference list 176 that includes a first reference list associated with the image frame 116A, the reference list 176N associated with the image frame 116N, one or more additional reference lists associated with one or more additional image frames of the sequence, or a combination thereof. For example, the reference list 176 includes one or more VRF identifiers 196 associated with the image frame 116A, the one or more VRF identifiers 196N associated with the image frame 116N, one or more VRF identifiers 196 associated with one or more additional image frames 116, or a combination thereof. As another example, the reference list 176 includes one or more frame identifiers 126 as one or more encoder reference candidate identifiers 174 associated with the image frame 116A, one or more frame identifiers 126 as one or more encoder reference candidate identifiers 174 associated with the image frame 116N, one or more additional frame identifiers 126 as one or more encoder reference candidate identifiers 174 associated with one or more additional image frames 116, or a combination thereof.

The system 100 thus enables generating VRFs 156 that retain perceptually important features (e.g., facial landmarks). A technical advantage of using the synthesis support data 150N (e.g., the facial landmark data, the motion-based data, or both) to generate the one or more VRFs 156N can include the one or more VRFs 156N being a closer approximation of the image frame 116N thus improving video quality of decoded image frames.

Although the camera 110 is illustrated as external to the device 102, in other implementations the camera 110 can be integrated in the device 102. Although the video analyzer 140 is illustrated as obtaining the image frames 116 from the camera 110, in other implementations the video analyzer 140 can obtain the image frames 116 from another component (e.g., a graphics processor) of the device 102, another device (e.g., a storage device, a network device, etc.), or a combination thereof. The camera 110 is illustrated as an example of an image capture device, in some implementations the video analyzer 140 can obtain the image frames 116 from various types of image capture devices, such as an extended reality (XR) device, a vehicle, the camera 110, a graphics processor, or a combination thereof.

Although the frame analyzer 142, the VRF generator 144, the video encoder 146, and the modem 170 are illustrated as separate components, in other implementations two or more of the frame analyzer 142, the VRF generator 144, the video encoder 146, or the modem 170 can be combined into a single component. Although the frame analyzer 142, the VRF generator 144, and the video encoder 146 are illustrated as included in a single device (e.g., the device 102), in other implementations one or more operations described herein with reference to the frame analyzer 142, the VRF generator 144, or the video encoder 146 can be performed at another device. Optionally, in some implementations, the video analyzer 140 can receive the image frames 116, the synthesis support data 150, or both, from another device.

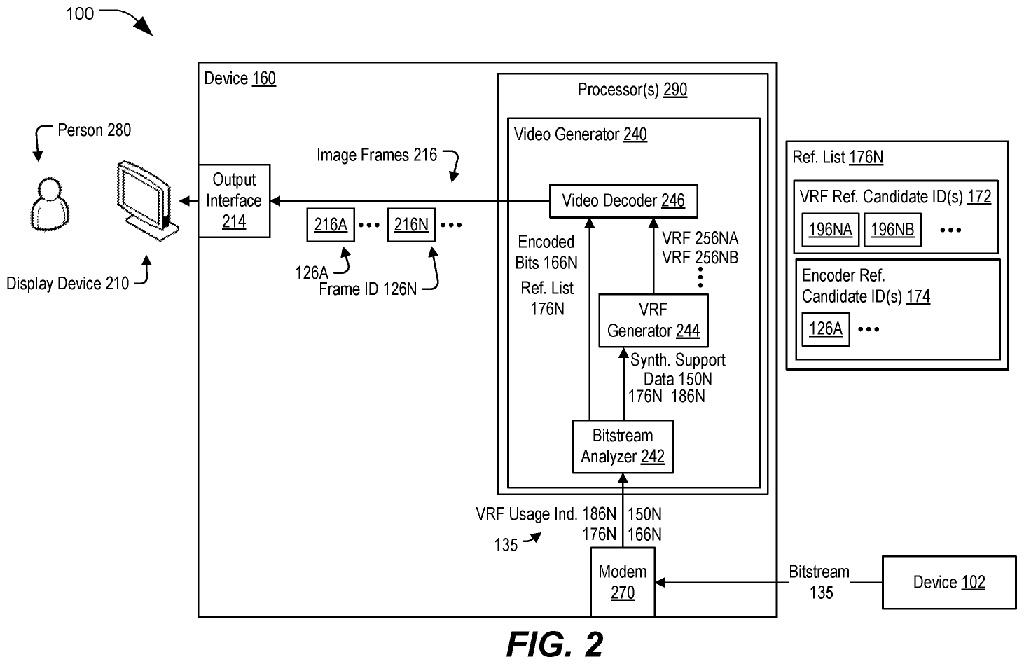

Referring to FIG. 2, a particular illustrative aspect of the system 100 is shown. The system 100 is operable to generate virtual reference frames for image decoding. The device 160 is configured to be coupled to a display device 210, the device 102, or both.

The device 102 includes an output interface 214, one or more processors 290, and a modem 270. The output interface 214 is coupled to the one or more processors 290 and configured to be coupled to the display device 210.

The modem 270 is coupled to the one or more processors 290 and is configured to enable communication with the device 102, such as to receive the bitstream 135 via wireless transmission from the device 102. For example, the bitstream 135 includes the reference list 176N, the encoded bits 166N, the synthesis support data 150N, the VRF usage indicator 186N, or a combination thereof.

The one or more processors 290 are coupled to the modem 270 and include a video generator 240. The video generator 240 includes a bitstream analyzer 242 coupled to a VRF generator 244 and to a video decoder 246. The VRF generator 244 is coupled to the video decoder 246. The bitstream analyzer 242 is also coupled to the modem 270.

The bitstream analyzer 242 is configured to obtain, from the modem 270, data from the bitstream 135 corresponding to an encoded version of the image frame 116N of FIG. 1. To illustrate, the bitstream 135 includes the encoded bits 166N, the VRF usage indicator 186N, the reference list 176N, or a combination thereof. If the bitstream 135 includes the VRF usage indicator 186N having a particular value (e.g., 1, 2, or 3) indicating VRF usage, the bitstream 135 also includes the synthesis support data 150N.

The bitstream analyzer 242 is configured to, in response to determining that the bitstream 135 includes the VRF usage indicator 186N having a particular value (e.g., 1, 2, or 3) indicating VRF usage, extract the synthesis support data 150N from the bitstream 135 and provide the synthesis support data 150N to the VRF generator 244. In some implementations, the bitstream analyzer 242 is configured to provide the VRF usage indicator 186N, the reference list 176N, or both, to the VRF generator 244. The bitstream analyzer 242 is configured to provide the encoded bits 166N, the reference list 176N, or both, to the video decoder 246.

The VRF generator 244 is configured to selectively generate one or more VRFs 256N for generating a decoded version of the image frame 116N. For example, the VRF generator 244 is configured to determine, based on the synthesis support data 150N, the reference list 176N, the VRF usage indicator 186N, or a combination thereof associated with the image frame 116N, whether at least one VRF is to be used to generate a decoded version of the image frame 116N. The VRF generator 244 is configured to, in response to determining that at least one VRF is to be used, generate one or more VRFs 256N based on the synthesis support data 150N. For example, the VRF generator 244 is configured to generate the one or more VRFs 256N based on facial landmark data, motion-based data, or both, indicated by the synthesis support data 150N.

The video decoder 246 is configured to generate a sequence of image frames 216 corresponding to a decoded version of the sequence of image frames 116. In an example, the image frames 216 includes an image frame 216A, an image frame 216N, one or more additional image frames, or a combination thereof. Each of the image frames 216 is associated with a frame identifier 126. For example, the image frame 216A, corresponding to a decoded version of the image frame 116A, includes the frame identifier 126A of the image frame 116A. As another example, the image frame 216N, corresponding to a decoded version of the image frame 116N, includes the frame identifier 126N of the image frame 116N.

The video decoder 246 is configured to generate an image frame 216 selectively based on corresponding one or more VRFs 256. For example, the video decoder 246 is configured to generate the image frame 216N based on the encoded bits 166N, the one or more VRFs 256N, the reference list 176N, or a combination thereof. In some implementations, the video generator 240 is configured to provide the image frames 216 via the output interface 214 to the display device 210. In a particular implementation, the video generator 240 is configured to provide the image frames 216 to the display device 210 in a playback order indicated by the frame identifiers 126. For example, the video generator 240, during forward playback and based on determining that the frame identifier 126A is less than the frame identifier 126N, provides the image frame 216A to the display device 210 for earlier playback than the image frame 216N. In a particular example, a person 280 can view the image frames 216 displayed by the display device 210.

In some implementations, the device 160 corresponds to or is included in one of various types of devices. In an illustrative example, the one or more processors 290 are integrated in at least one of a mobile phone or a tablet computer device, as described with reference to FIG. 14, a wearable electronic device, as described with reference to FIG. 15, a camera device, as described with reference to FIG. 16, or a virtual reality, mixed reality, or augmented reality headset, as described with reference to FIG. 17. In another illustrative example, the one or more processors 290 are integrated into a vehicle, such as described further with reference to FIG. 18 and FIG. 19.

During operation, the video generator 240 obtains the bitstream 135 corresponding to an encoded version of the image frame 116N of FIG. 1. For example, the bitstream 135 includes the encoded bits 166N, the VRF usage indicator 186N, the reference list 176N, or a combination thereof, associated with the image frame 116N. In some examples, the bitstream 135 also includes the synthesis support data 150N associated with the image frame 116N. In a particular aspect, the encoded bits 166N, the VRF usage indicator 186N, the reference list 176N, the synthesis support data 150N, or a combination thereof, indicate the frame identifier 126N of the image frame 116N.

In a particular example, the video generator 240 obtains the bitstream 135 via the modem 270. In another example, the video generator 240 obtains the bitstream 135 from a storage device, a network device, another component of the device 160, or a combination thereof.

The video generator 240 selectively generates VRFs for determining decoded versions of the image frames 116. In an example, the bitstream analyzer 242, in response to determining that the bitstream 135 does not include the VRF usage indicator 186N or that the VRF usage indicator 186N has a first value (e.g., 0) indicating no VRF usage, determines that no VRFs are to be used to generate an image frame 216N corresponding to a decoded version of the image frame 116N. Alternatively, the bitstream analyzer 242, in response to determining that the bitstream 135 includes the VRF usage indicator 186N having a particular value (e.g., 1, 2, or 3) indicating VRF usage, determines that at least one VRF is to be used to generate the image frame 216N.

The bitstream analyzer 242, in response to determining that at least one VRF is to be used to generate the image frame 216N, provides the synthesis support data 150N, the reference list 176N, the VRF usage indicator 186N, or a combination thereof, to the VRF generator 244 to generate at least one VRF. The bitstream analyzer 242 also provides the encoded bits 166N, the reference list 176N, or both, to the video decoder 246 to generate the image frame 216N. In some examples, the bitstream analyzer 242, the VRF generator 244, or both, provide the VRF usage indicator 186N to the video decoder 246.

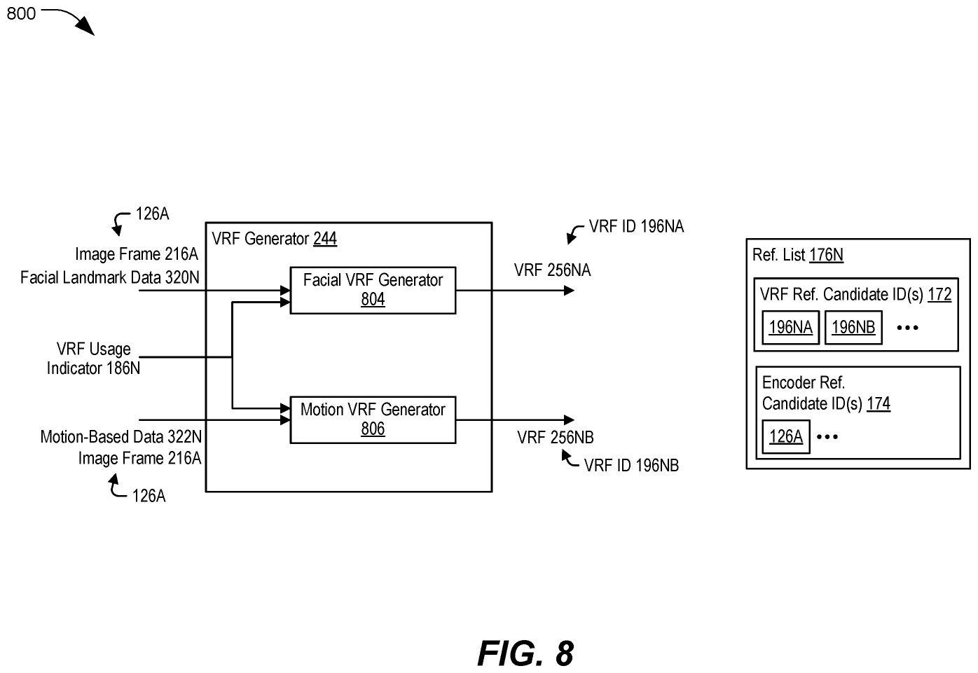

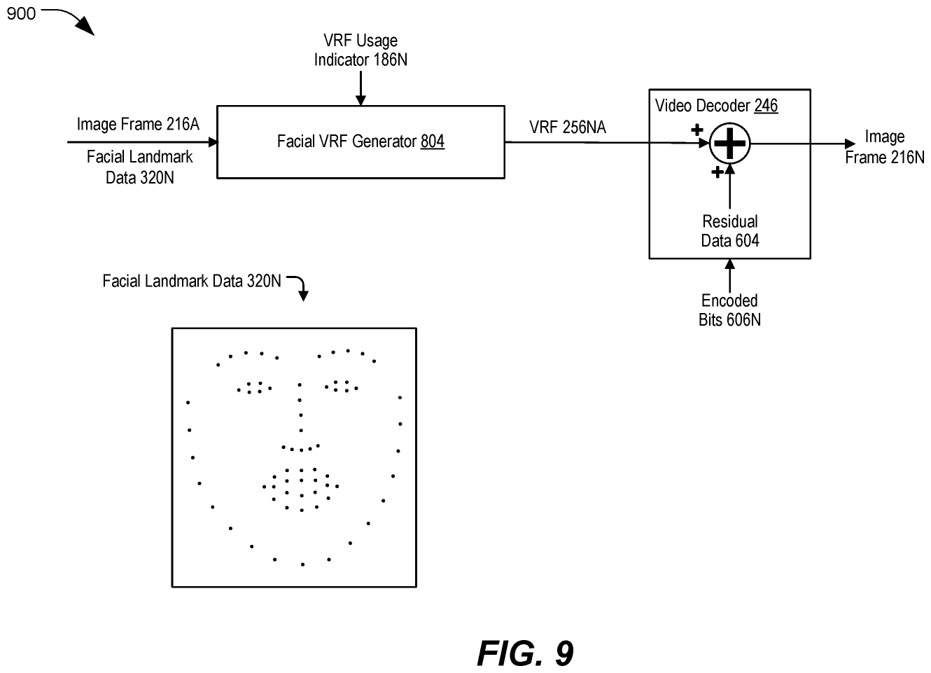

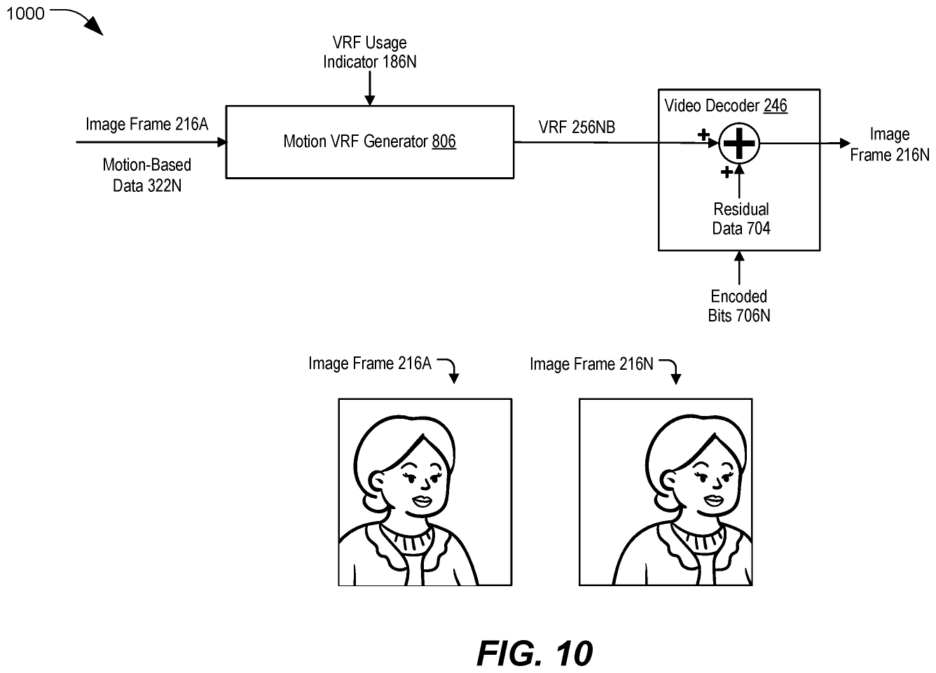

The VRF generator 244, in response to determining that the bitstream 135 includes the VRF usage indicator 186N having a particular value (e.g., 1, 2, or 3) indicating VRF usage, generates one or more VRFs 256N as one or more VRF reference candidates to be used to generate the image frame 216N. For example, the VRF generator 244, responsive to determining that the VRF usage indicator 186N has a particular value (e.g., 1 or 3) indicating facial VRF usage, generates at least a VRF 256NA based on facial landmark data included in the synthesis support data 150N, as further described with reference to FIGS. 8 and 9. The VRF generator 244, responsive to determining that the VRF usage indicator 186N has a particular value (e.g., 2 or 3) indicating motion VRF usage, generates at least a VRF 256NB based on motion-based data included in the synthesis support data 150N, as further described with reference to FIGS. 8 and 10.

As described with reference to FIG. 1, the reference list 176N includes one or more VRF reference candidate identifiers 172. For example, the one or more VRF reference candidate identifiers 172 include a VRF identifier 196NA of the VRF 156NA, a VRF identifier 196NB of the VRF 156NB, one or more additional VRF identifiers of one or more additional VRFs, or a combination thereof.

The VRF generator 244 assigns the one or more VRF identifiers 196N to the one or more VRFs 256N. In a particular example, the VRF generator 244, in response to determining that the facial landmark data is associated with the VRF identifier 196NA, assigns the VRF identifier 196NA to the VRF 256NA that is generated based on the facial landmark data. The VRF 256NA thus corresponds to the VRF 156NA generated at the video analyzer 140 of FIG. 1. In another example, the VRF generator 244, in response to determining that the motion-based data is associated with the VRF identifier 196NB, assigns the VRF identifier 196NB to the VRF 256NB that is generated based on the motion-based data. The VRF 256NB thus corresponds to the VRF 156NB generated at the video analyzer 140 of FIG. 1. The VRF generator 244 provides the one or more VRFs 256N to the video decoder 246.

The video decoder 246 is configured to generate the image frame 216N (e.g., a decoded version of the image frame 116N of FIG. 1) based at least on the encoded bits 166N. In a particular aspect, the video decoder 246 selectively generates the image frame 216N based on the one or more VRFs 256N. As described with reference to FIG. 1, the reference list 176N includes the one or more VRF reference candidate identifiers 172 of a first set of reference candidates (e.g., the one or more VRFs 256N), the one or more encoder reference candidate identifiers 174 of a second set of reference candidates (e.g., one or more previously decoded image frames 216), or a combination thereof.

In a particular example, the reference list 176N is empty and the video decoder 246 generates the image frame 216N by processing (e.g., decoding) the encoded bits 166N independently of any reference candidates. As an illustrative example, the image frame 216N can correspond to an i-frame.

In a particular example, the video decoder 246 selects, based on a selection criterion, one or more of the reference candidates indicated in the reference list 176N to generate the image frame 216N. The selection criterion can be based on a user input, default data, a configuration setting, a threshold reference count, or a combination thereof. In an example, the video decoder 246 selects one or more of the second set of reference candidates (e.g., the encoder reference candidates) if the reference list 176N does not indicate any of the first set of reference candidates (e.g., the one or more VRFs 256N). Alternatively, the video decoder 246 generates the image frame 216N based on the one or more VRFs 256N and independently of the encoder reference candidates if the reference list 176N indicates at least one of the one or more VRFs 256N.

The video decoder 246 applies the encoded bits 166N (e.g., a residual) to a selected one of the reference candidates to generate a decoded image frame. For example, the video decoder 246 applies a first subset of the encoded bits 166N to the VRF 256NA to generate a first decoded image frame, as further described with reference to FIG. 9. As another example, the video decoder 246 applies a second subset of the encoded bits 166N to the VRF 256NB to generate a second decoded image frame, as further described with reference to FIG. 10. In yet another example, the video decoder 246 applies a third subset of the encoded bits 166N to the image frame 216A to generate a third decoded image frame.

In a particular implementation in which the video decoder 246 selects a single one of the reference candidates (e.g., the VRF 256NA, the VRF 256NB, or the image frame 216A), the corresponding decoded image frame (e.g., the first decoded image frame, the second decoded image frame, or the third decoded image frame) is designated as the image frame 216N.

In a particular implementation in which the video decoder 246 selects multiple reference candidates (e.g., the VRF 256NA, the VRF 256NB, and the image frame 216A), the video decoder 246 generates the image frame 216N based on a combination of the corresponding decoded image frames (e.g., the first decoded image frame, the second decoded image frame, and the third decoded image frame). For example, the video decoder 246 generates the image frame 216N by averaging the decoded image frames (e.g., the first decoded image frame, the second decoded image frame, and the third decoded image frame) on a pixel-by-pixel basis, or using information in the bitstream 135 indicating how to combine (e.g., weights for a weighted sum of) the decoded image frames.

In an illustrative example, the video generator 240 provides the image frame 216N via the output interface 214 to the display device 210. Optionally, in some implementations, the video generator 240 provides the image frame 216N to a storage device, a network device, a user device, or a combination thereof.

The system 200 thus enables using VRFs 256 that retain perceptually important features (e.g., facial landmarks) to generate decoded image frames (e.g., the image frame 216N). A technical advantage of using the synthesis support data 150N (e.g., the facial landmark data, the motion-based data, or both) to generate the one or more VRFs 256N can include the one or more VRFs 256N being a closer approximation (as compared to the image frame 216A) of the image frame 116N thus improving video quality of the image frame 216N.

Although the display device 210 is illustrated as external to the device 160, in other implementations the display device 210 can be integrated in the device 160. Although the video generator 240 is illustrated as receiving the bitstream 135 via the modem 270 from the device 102, in other implementations the video generator 240 can obtain the bitstream 135 from another component (e.g., a graphics processor) of the device 160, another device (e.g., a storage device, a network device, etc.), or a combination thereof. In a particular implementation, the device 102, the device 160, or both, can include a copy of the video analyzer 140 and a copy of the video generator 240. For example, the video analyzer 140 of the device 102 generates the bitstream 135 from the image frames 116 received from the camera 110, the video analyzer 140 stores the bitstream 135 in a memory, the video generator 240 of the device 102 retrieves the bitstream 135 from the memory, the video generator 240 generates the image frames 216 from the bitstream 135, and the video generator 240 provides the image frames 216 to a display device.

Although the bitstream analyzer 242, the VRF generator 244, the video decoder 246, and the modem 270 are illustrated as separate components, in other implementations two or more of the bitstream analyzer 242, the VRF generator 244, the video decoder 246, or the modem 270 can be combined into a single component. Although the bitstream analyzer 242, the VRF generator 244, and the video decoder 246 are illustrated as included in a single device (e.g., the device 160), in other implementations one or more operations described herein with reference to the bitstream analyzer 242, the VRF generator 244, or the video decoder 246 can be performed at another device.

Referring to FIG. 3, a diagram 300 is shown of an illustrative aspect of operations associated with the frame analyzer 142 and the VRF generator 144, in accordance with some examples of the present disclosure. The frame analyzer 142 includes a visual analytics engine 312 coupled to a synthesis support analyzer 314.

The visual analytics engine 312 includes a face detector 302, a facial landmark detector 304, and a global motion detector 306. The face detector 302 uses facial recognition techniques to generate a face detection indicator 318N indicating whether at least one face is detected in the image frame 116N. For example, the face detection indicator 318N has a first value (e.g., 0) to indicate that no face is detected in the image frame 116N or a second value (e.g., 1) to indicate that at least one face is detected in the image frame 116N.

The facial landmark detector 304, in response to determining that the face detection indicator 318N indicates that at least one face is detected in the image frame 116N, uses facial analysis techniques to generate facial landmark data 320N indicating locations of facial features detected in the image frame 116N and includes the facial landmark data 320N in the synthesis support data 150N, as further described with reference to FIG. 6.

The global motion detector 306 uses global motion detection techniques to generate a motion detection indicator 316N indicating whether at least a threshold global motion is detected in the image frame 116N relative to the image frame 116A. For example, the motion detection indicator 316N has a first value (e.g., 0) to indicate that at least a threshold global motion is not detected in the image frame 116N or a second value (e.g., 1) to indicate that at least the threshold global motion is detected in the image frame 116N.

The global motion detector 306 uses motion analysis techniques to generate motion-based data 322N indicating the global motion detected in the image frame 116N and, in response to determining that the motion detection indicator 316N indicates that at least the threshold global motion is detected in the image frame 116N, includes the motion-based data 322N in the synthesis support data 150N, as further described with reference to FIG. 7. In a particular implementation, the global motion detector 306 generates the motion-based data 322N (e.g., a global motion vector) based on a comparison of the image frame 116A and the image frame 116N. In some implementations, the global motion detector 306 also, or alternatively, receives sensor data indicating first position of the camera 110 at a first capture time of the image frame 116A and second position of the camera 110 at a second capture time of the image frame 116N. The global motion detector 306 determines the global motion based on a comparison of (e.g., a difference between) the first position and the second position. The global motion detector 306, in response to determining that is global motion is greater than a threshold global motion, generates the motion-based data 322N indicating the difference between the second position and the first position. The visual analytics engine 312 provides the motion detection indicator 316N and the face detection indicator 318N to the synthesis support analyzer 314.

The synthesis support analyzer 314 generates the VRF usage indicator 186N based on the motion detection indicator 316N, the face detection indicator 318N, or both. For example, the VRF usage indicator 186N has a first value (e.g., 0) indicating no VRF usage corresponding to the first value (e.g., 0) of the motion detection indicator 316N and the first value (e.g., 0) of the face detection indicator 318N. In another example, the VRF usage indicator 186N has a second value (e.g., 1) indicating no motion VRF usage and facial VRF usage, corresponding to the first value (e.g., 0) of the motion detection indicator 316N and the second value (e.g., 1) of the face detection indicator 318N. The VRF usage indicator 186N has a third value (e.g., 2) indicating motion VRF usage and no facial VRF usage, corresponding to the second value (e.g., 1) of the motion detection indicator 316N and the first value (e.g., 0) of the face detection indicator 318N. The VRF usage indicator 186N has a fourth value (e.g., 3) indicating motion VRF usage and facial VRF usage, corresponding to the second value (e.g., 1) of the motion detection indicator 316N and the second value (e.g., 1) of the face detection indicator 318N. In a particular implementation, each of the motion detection indicator 316N and the face detection indicator 318N is a one-bit value and the VRF usage indicator 186N is a two-bit value corresponding to a concatenation of the motion detection indicator 316N and the face detection indicator 318N.

The frame analyzer 142 provides the VRF usage indicator 186N to the VRF generator 144. When the VRF usage indicator 186N has a particular value (e.g., 1, 2, or 3) indicating VRF usage, the frame analyzer 142 also provides the synthesis support data 150N to the VRF generator 144. The VRF generator 144, in response to determining that the VRF usage indicator 186N has a particular value (e.g., 1 or 3) indicating that the synthesis support data 150N includes the facial landmark data 320N, generates the VRF 156NA based on the facial landmark data 320N, as further described with reference to FIG. 6. The VRF generator 144 generates the VRF identifier 196NA of the VRF 156NA and adds the VRF identifier 196NA to the one or more VRF reference candidate identifiers 172 of the reference list 176N, as described with reference to FIG. 1.

The VRF generator 144, in response to determining that the VRF usage indicator 186N has a particular value (e.g., 2 or 3) indicating that the synthesis support data 150N includes the motion-based data 322N, generates the VRF 156NB based on the motion-based data 322N, as further described with reference to FIG. 7. The VRF generator 144 generates the VRF identifier 196NB of the VRF 156NB and adds the VRF identifier 196NB to the one or more VRF reference candidate identifiers 172 of the reference list 176N, as described with reference to FIG. 1.

The visual analytics engine 312 including both the facial landmark detector 304 and the global motion detector 306 is provided as an illustrative implementation. Optionally, in some implementations, the visual analytics engine 312 can include a single one of the facial landmark detector 304 or the global motion detector 306, and the synthesis support data 150N can include the corresponding one of the facial landmark data 320N or the motion-based data 322N. A technical advantage of the visual analytics engine 312 including a single one of the facial landmark detector 304 or the global motion detector 306 can include less hardware, lower memory usage, fewer computing cycles, or a combination thereof, used by the visual analytics engine 312. A technical advantage of the visual analytics engine 312 including both the facial landmark detector 304 and the global motion detector 306 can include enhanced image frame reproduction quality, reduced usage of transmission resources, or both, as compared to including a single one of the facial landmark detector 304 or the global motion detector 306. Another technical advantage of the visual analytics engine 312 including both the facial landmark detector 304 and the global motion detector 306 can include compatibility with decoders that include support for facial VRF, motion VRF, or both.

Referring to FIG. 4, a diagram 400 is shown of an illustrative aspect of operations associated with the synthesis support analyzer 314 to generate the VRF usage indicator 186N of FIG. 1, in accordance with some examples of the present disclosure. In a particular aspect, the synthesis support analyzer 314 initializes the VRF usage indicator 186N to a first value (e.g., 0) indicating no VRF usage.

At 402, the synthesis support analyzer 314 determines whether an encoder reference candidates count indicated by the one or more encoder reference candidate identifiers 174 of FIG. 1 is less than a threshold reference count.

The synthesis support analyzer 314, in response to determining that the encoder reference candidates count is not less than (i.e., is greater than or equal to) the threshold reference count, at 402, outputs the VRF usage indicator 186N of FIG. 1 having the first value (e.g., 0) indicating no VRF usage, at 404. Alternatively, the synthesis support analyzer 314, in response to determining that the count of encoder reference candidates is less than the threshold reference count, at 402, determines whether the face detection indicator 318N of FIG. 3 indicates that at least one face is detected in the image frame 116N, at 406.

The synthesis support analyzer 314, in response to determining that the face detection indicator 318N indicates that at least one face is detected in the image frame 116N, updates the VRF usage indicator 186N to a second value (e.g., 1) to indicate facial VRF usage, at 408. At 410, the synthesis support analyzer 314 determines whether a sum of the encoder reference candidates count and one is less than the threshold reference count.

The synthesis support analyzer 314, in response to determining that the face detection indicator 318N indicates that no face is detected in the image frame 116N, at 406, or that the sum of the encoder reference candidates count and one is less than the threshold reference count, at 410, determines whether the motion detection indicator 316N of FIG. 3 indicates that greater than threshold global motion is detected in the image frame 116N, at 412.

The synthesis support analyzer 314, in response to determining that the motion detection indicator 316N indicates that greater than threshold global motion is detected in the image frame 116N, at 412, updates the VRF usage indicator 186N to indicate motion VRF usage. For example, the synthesis support analyzer 314, in response to determining that the VRF usage indicator 186N has the first value (e.g., 0) indicating no facial VRF usage, sets the VRF usage indicator 186N to a third value (e.g., 2) indicating motion VRF usage and no facial VRF usage. As another example, the synthesis support analyzer 314, in response to determining that the VRF usage indicator 186N indicates the second value (e.g., 1) indicating facial VRF usage, sets the VRF usage indicator 186N to a fourth value (e.g., 3) to indicate motion VRF usage in addition to facial VRF usage.

Alternatively, the synthesis support analyzer 314, in response to determining that a sum of the encoder reference candidates count and one is greater than or equal to the threshold reference count, at 410, or that the motion detection indicator 316N indicates that greater than threshold global motion is not detected in the image frame 116N, at 412, outputs the VRF usage indicator 186N indicating no motion VRF usage. For example, the synthesis support analyzer 314 refrains from updating the VRF usage indicator 186N having the first value (e.g., 0) indicating no VRF usage or having the second value (e.g., 1) indicating facial VRF usage and no motion VRF usage.

The diagram 400 is an illustrative example of operations performed by the synthesis support analyzer 314. Optionally, in some implementations, the synthesis support analyzer 314 can generate the VRF usage indicator 186N based on a single one of the motion detection indicator 316N or the face detection indicator 318N. Optionally, in some implementations in which the VRF usage indicator 186N is based on the face detection indicator 318N and not based on the motion detection indicator 316N, the synthesis support analyzer 314 performs the operations 402, 404, 406, and 408, and does not perform the operations 410, 412, 414, and 416. To illustrate, the synthesis support analyzer 314, in response to determining that the encoder reference candidates count is less than the threshold reference count, at 402, and that the face detection indicator 318N indicates that at least one face is detected in the image frame 116N, at 406, outputs the VRF usage indicator 186N having a second value (e.g., 1) indicating facial VRF usage, at 408. Alternatively, the synthesis support analyzer 314, in response to determining that the encoder reference candidates count is greater than or equal to the threshold reference count, at 402, or that the face detection indicator 318N indicates that no face is detected in the image frame 116N, at 406, proceeds to 404 and outputs the VRF usage indicator 186N having a first value (e.g., 0) indicating no VRF usage.

Optionally, in some implementations in which the VRF usage indicator 186N is based on the motion detection indicator 316N and not based on the face detection indicator 318N, the synthesis support analyzer 314 performs the operations 402, 404, 412, and 414, and does not perform the operations 406, 408, 410, and 416. To illustrate, the synthesis support analyzer 314, in response to determining that the encoder reference candidates count is less than the threshold reference count, at 402, and that the motion detection indicator 316N indicates that at least threshold global motion is detected in the image frame 116N, at 412, outputs the VRF usage indicator 186N having a third value (e.g., 2) indicating motion VRF usage, at 414. Alternatively, the synthesis support analyzer 314, in response to determining that the encoder reference candidates count is greater than or equal to the threshold reference count, at 402, or that the motion detection indicator 316N indicates that greater than threshold global motion is not detected in the image frame 116N, at 412, proceeds to 404 and outputs the VRF usage indicator 186N having a first value (e.g., 0) indicating no VRF usage.

Referring to FIG. 5, a diagram 500 is shown of an illustrative aspect of operations associated with the VRF generator 144, in accordance with some examples of the present disclosure. The VRF generator 144 includes a facial VRF generator 504 and a motion VRF generator 506.

The facial VRF generator 504, in response to determining that the VRF usage indicator 186N has a particular value (e.g., 1 or 3) indicating facial VRF usage, processes the image frame 116A (or a locally decoded version of the image frame 116A) based on the facial landmark data 320N to generate the VRF 156NA, as further described with reference to FIG. 6. The facial VRF generator 504 assigns the VRF identifier 196NA to the VRF 156NA and adds the VRF identifier 196NA to the one or more VRF reference candidate identifiers 172 in the reference list 176N.

The motion VRF generator 506, in response to determining that the VRF usage indicator 186N has a particular value (e.g., 2 or 3) indicating motion VRF usage, processes the image frame 116A (or a locally decoded version of the image frame 116A) based on the motion-based data 322N to generate the VRF 156NB, as further described with reference to FIG. 7. The motion VRF generator 506 assigns the VRF identifier 196NB to the VRF 156NB and adds the VRF identifier 196NB to the one or more VRF reference candidate identifiers 172 in the reference list 176N.

The VRF generator 144 including both the facial VRF generator 504 and the motion VRF generator 506 is provided as an illustrative example. Optionally, in some implementations, the VRF generator 144 can include a single one of the facial VRF generator 504 or the motion VRF generator 506. A technical advantage of including a single one of the facial VRF generator 504 or the motion VRF generator 506 can include less hardware, lower memory usage, fewer computing cycles, or a combination thereof, used by the VRF generator 144. A technical advantage of the VRF generator 144 including both the facial VRF generator 504 and the motion VRF generator 506 can include enhanced image frame reproduction quality, reduced usage of transmission resources, or both, as compared to including a single one of the facial landmark detector 304 or the global motion detector 306. Another technical advantage of the visual analytics engine 312 including both the facial landmark detector 304 and the global motion detector 306 can include compatibility with decoders that include support for facial VRF, motion VRF, or both.

Referring to FIG. 6, a diagram 600 is shown of an illustrative aspect of operations associated with the facial VRF generator 504 and the video encoder 146, in accordance with some examples of the present disclosure.

The facial VRF generator 504, in response to determining that the VRF usage indicator 186N has a particular value (e.g., 1 or 3) indicating facial VRF usage, applies the facial landmark data 320N to the image frame 116A (or a locally decoded version of the image frame 116A). For example, the facial landmark data 320N indicates positions of facial features in the image frame 116N. A graphical representation of the facial landmark data 320N is shown in FIG. 6 illustrating the positions of the facial features detected in the image frame 116N. To illustrate, eyes of a person may be depicted in the image frame 116N as open wider relative to depiction of the eyes in the image frame 116A.

Applying the facial landmark data 320N to the image frame 116A (or the locally decoded version of the image frame 116A) adjusts positions of the facial features in the image frame 116A (or the locally decoded version of the image frame 116A) to generate the VRF 156NA as an estimate of the image frame 116N. To illustrate, the adjusted positions of the facial features in the VRF 156NA may more closely match positions (or relative positions) of the facial features in the image frame 116N. In a particular implementation, the facial VRF generator 504 generates a facial model corresponding to the positions of the facial features detected in the image frame 116A. The facial VRF generator 504 updates the facial model based on updated positions of the facial features indicated in the facial landmark data 320N. The facial VRF generator 504 generates the VRF 156NA corresponding to the updated facial model.

The facial landmark data 320N indicating positions of facial features detected in the image frame 116N is provided as an illustrative example. Optionally, in some implementations, the facial landmark data 320N indicates positions of facial features detected in the image frame 116N that are distinct (e.g., updated) from positions of the facial features detected in the image frame 116A.

In a particular implementation, the facial VRF generator 504 includes a trained model (e.g., a neural network). The facial VRF generator 504 uses the trained model to process the image frame 116A (or the locally decoded version of the image frame 116A) and the facial landmark data 320N to generate the VRF 156NA.

The facial VRF generator 504 provides the VRF 156NA to the video encoder 146. The video encoder 146 determines residual data 604 based on a comparison of (e.g., a difference between) the image frame 116N and the VRF 156NA. The video encoder 146 generates encoded bits 606N corresponding to the residual data 604. For example, the video encoder 146 encodes the residual data 604 to generate the encoded bits 606N. The encoded bits 606N are included as a first subset of the encoded bits 166N of FIG. 1 that is associated with facial VRF usage. In a particular aspect, the facial landmark data 320N and the encoded bits 606N correspond to fewer bits as compared to an encoded version of first residual data that is based on a difference between the image frame 116A (or the locally decoded version of the image frame 116A) and the image frame 116N. In an example, the residual data 604 has smaller numerical values, and less variance overall, as compared to the first residual data, so the residual data 604 can be encoded more efficiently (e.g., using fewer bits). A technical advantage of providing the facial landmark data 320N and the residual data 604 (instead of the first residual data) in the bitstream 135 can include using fewer resources (e.g., bandwidth, time, or both).

Referring to FIG. 7, a diagram 700 is shown of an illustrative aspect of operations associated with the motion VRF generator 506 and the video encoder 146, in accordance with some examples of the present disclosure.

The motion VRF generator 506, in response to determining that the VRF usage indicator 186N has a particular value (e.g., 2 or 3) indicating motion VRF usage, applies the motion-based data 322N to the image frame 116A (or a locally decoded version of the image frame 116A). For example, the motion-based data 322N indicates global motion (e.g., rotation, translation, or both) detected in the image frame 116N relative to the image frame 116A (or the locally decoded version of the image frame 116A). In another example, the motion-based data 322N indicates global motion of a camera that moved to the left between a first capture time of the image frame 116A and a second capture time of the image frame 116N.

Applying the motion-based data 322N to the image frame 116A (or the locally decoded version of the image frame 116A) applies the global motion to the image frame 116A (or the locally decoded version of the image frame 116A) to generate the VRF 156NB as an estimate of the image frame 116N. For example, the motion VRF generator 506 uses the motion-based data 322N to warp the image frame 116A (or the locally decoded version of the image frame 116A) to generate the VRF 156NB. In a particular implementation, the motion VRF generator 506 includes a trained model (e.g., a neural network). The motion VRF generator 506 uses the trained model to process the image frame 116A (or the locally decoded version of the image frame 116A) and the motion-based data 322N to generate the VRF 156NB. For example, the image frame 116A (or the locally decoded version of the image frame 116A) and the motion-based data 322N are provided as an input to the trained model and an output of the trained model indicates the VRF 156NB.

The motion VRF generator 506 provides the VRF 156NB to the video encoder 146. The video encoder 146 determines residual data 704 based on a comparison of (e.g., a difference between) the image frame 116N and the VRF 156NB. The video encoder 146 generates encoded bits 706N corresponding to the residual data 704. For example, the video encoder 146 encodes the residual data 704 to generate the encoded bits 706N. The encoded bits 706N are included as a second subset of the encoded bits 166N of FIG. 1 that is associated with motion VRF usage. In a particular aspect, the motion-based data 322N and the encoded bits 706N correspond to fewer bits as compared to an encoded version of first residual data that is based on a difference between the image frame 116A (or the locally decoded version of the image frame 116A) and the image frame 116N. In an example, the residual data 704 has smaller numerical values, and less variance overall, as compared to the first residual data, so the residual data 704 can be encoded more efficiently (e.g., using fewer bits). A technical advantage of providing the motion-based data 322N and the residual data 704 (instead of the first residual data) in the bitstream 135 can include using fewer resources (e.g., bandwidth, time, or both).

Referring to FIG. 8, a diagram 800 is shown of an illustrative aspect of operations associated with the VRF generator 244, in accordance with some examples of the present disclosure. The VRF generator 244 includes a facial VRF generator 804 and a motion VRF generator 806.

The facial VRF generator 804, in response to determining that the VRF usage indicator 186N has a particular value (e.g., 1 or 3) indicating facial VRF usage, processes the image frame 216A based on the facial landmark data 320N to generate the VRF 256NA, as further described with reference to FIG. 9. The facial VRF generator 804, in response to determining that the reference list 176N includes the VRF identifier 196NA associated with facial VRF usage, that the facial landmark data 320N is associated with the VRF identifier 196NA, or both, assigns the VRF identifier 196NA to the VRF 256NA.

The motion VRF generator 806, in response to determining that the VRF usage indicator 186N has a particular value (e.g., 2 or 3) indicating motion VRF usage, processes the image frame 216A based on the motion-based data 322N to generate the VRF 256NB, as further described with reference to FIG. 10. The motion VRF generator 806, in response to determining that the reference list 176N includes the VRF identifier 196NB associated with motion VRF usage, that the motion-based data 322N is associated with the VRF identifier 196NB, or both, assigns the VRF identifier 196NB to the VRF 256NB.

The VRF generator 244 including both the facial VRF generator 804 and the motion VRF generator 806 is provided as an illustrative example. Optionally, in some implementations, the VRF generator 244 can include a single one of the facial VRF generator 804 or the motion VRF generator 806. A technical advantage of including a single one of the facial VRF generator 804 or the motion VRF generator 806 can include less hardware, lower memory usage, fewer computing cycles, or a combination thereof, used by the VRF generator 244. A technical advantage of the VRF generator 244 including both the facial VRF generator 804 and the motion VRF generator 806 can include enhanced image frame reproduction quality, reduced usage of transmission resources, or both, as compared to including a single one of the facial VRF generator 804 or the motion VRF generator 806. Another technical advantage of the VRF generator 244 including both the facial VRF generator 804 and the motion VRF generator 806 can include compatibility with encoders that include support for facial VRF, motion VRF, or both.

Referring to FIG. 9, a diagram 900 is shown of an illustrative aspect of operations associated with the facial VRF generator 804 and the video decoder 246, in accordance with some examples of the present disclosure.

The facial VRF generator 804, in response to determining that the VRF usage indicator 186N has a particular value (e.g., 1 or 3) indicating facial VRF usage, applies the facial landmark data 320N to the image frame 216A.

Applying the facial landmark data 320N to the image frame 216A adjusts positions of the facial landmarks in the image frame 216A to more closely match positions (or relative positions) of the facial landmarks in the image frame 116N to generate the VRF 256NA. In a particular aspect, the facial VRF generator 804 generates a facial model corresponding to the positions of the facial landmarks detected in the image frame 216A. The facial VRF generator 804 updates the facial model based on updated positions of the facial landmarks indicated in the facial landmark data 320N. The facial VRF generator 804 generates the VRF 256NA corresponding to the updated facial model.

In a particular implementation, the facial VRF generator 804 includes a trained model (e.g., a neural network). The facial VRF generator 804 uses the trained model to process the image frame 216A and the facial landmark data 320N to generate the VRF 256NA.

The facial VRF generator 804 provides the VRF 256NA to the video decoder 246. The video decoder 246 decodes the encoded bits 606N (e.g., a first subset of the encoded bits 166N associated with facial VRF usage) to generate the residual data 604.

The facial VRF generator 804 generates the image frame 216N based on a combination of the VRF 256NA and the residual data 604. In a particular aspect, the facial landmark data 320N and the encoded bits 606N correspond to fewer bits as compared to an encoded version of first residual data that is based on a difference between the image frame 216A and the image frame 116N. A technical advantage of using the facial landmark data 320N and the residual data 604 to generate the image frame 216N can include generating the image frame 216N that is a better approximation of the image frame 116N using limited bits of the bitstream 135.

Referring to FIG. 10, a diagram 1000 is shown of an illustrative aspect of operations associated with the motion VRF generator 806 and the video decoder 246, in accordance with some examples of the present disclosure.

The motion VRF generator 806, in response to determining that the VRF usage indicator 186N has a particular value (e.g., 2 or 3) indicating motion VRF usage, applies the motion-based data 322N to the image frame 216A.

Applying the motion-based data 322N to the image frame 216A applies global motion to the image frame 216A to generate the VRF 256NB. For example, the motion VRF generator 806 warps the image frame 216A based on the motion-based data 322N to generate the VRF 256NB. In a particular implementation, the motion VRF generator 806 includes a trained model (e.g., a neural network). The motion VRF generator 806 uses the trained model to process the image frame 216A and the motion-based data 322N to generate the VRF 256NB. For example, the motion VRF generator 806 provides the image frame 216A and the motion-based data 322N as an input to the trained model and an output of the trained model indicates the VRF 256NB.

The motion VRF generator 806 provides the VRF 256NB to the video decoder 246. The video decoder 246 decodes the encoded bits 706N (e.g., a second subset of the encoded bits 166N associated with motion VRF usage) to generate the residual data 704. The motion VRF generator 806 generates the image frame 216N based on a combination of the VRF 256NB and the residual data 704. In a particular aspect, the motion-based data 322N and the encoded bits 706N correspond to fewer bits as compared to an encoded version of first residual data that is based on a difference between the image frame 216A and the image frame 116N. A technical advantage of using the motion-based data 322N and the residual data 704 to generate the image frame 216N can include generating the image frame 216N that is a better approximation of the image frame 116N using limited bits of the bitstream 135.

Generating the image frame 216N based on either the VRF 256NA corresponding to the facial landmark data 320N, as described with reference to FIG. 9, or the VRF 256NB corresponding to the motion-based data 322N, as described with reference to FIG. 10, is provided as an illustrative example. Optionally, in some implementations, the video decoder 246 generates the image frame 216N based on both the facial landmark data 320N and the motion-based data 322N. As an illustrative example, the video decoder 246 applies the facial landmark data 320N to the image frame 216A to generate the VRF 256NA, as described with reference to FIG. 9, and applies the motion-based data 322N to the VRF 256NA to generate the VRF 256NB. The video decoder 246 applies the residual data 704 to the VRF 156NB to generate the image frame 216N. In this example, the video encoder 146 applies the facial landmark data 320N to the image frame 116A to generate the VRF 156NA, as described with reference to FIG. 6, determines the motion-based data 322N based on a comparison of the VRF 156NA and the image frame 116N, applies the motion-based data 322N to the VRF 156NA to generate the VRF 156NB, and determines the residual data 704 based on a comparison of the VRF 156NB and the image frame 116N.

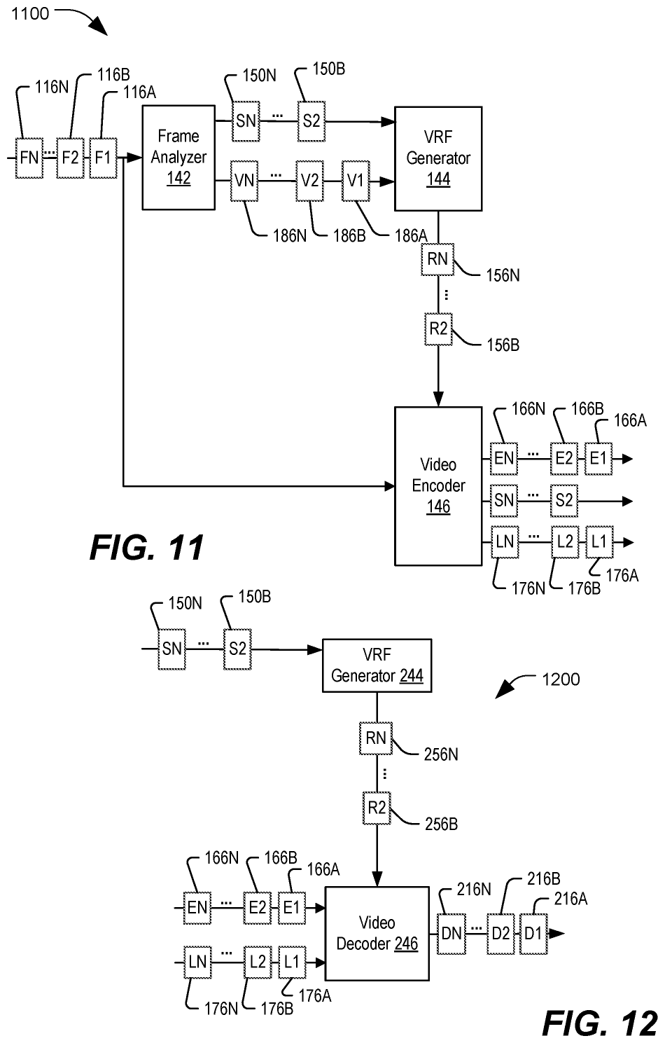

Referring to FIG. 11, a diagram 1100 is shown of an illustrative aspect of operation of the frame analyzer 142, the VRF generator 144, and the video encoder 146, in accordance with some examples of the present disclosure.

Each of the frame analyzer 142 and the video encoder 146 is configured to receive a sequence of image frames 116, such as a sequence of successively captured frames of image data, illustrated as a first image frame (F1) 116A, a second image frame (F2) 116B, and one or more additional image frames including an Nth image frame (FN) 116N (where N is an integer greater than two). The frame analyzer 142 is configured to output a sequence of VRF usage indicators including a first VRF usage indicator (V1) 186A, a second VRF usage indicator (V2) 186B, and one or more additional VRF usage indicators including an Nth VRF usage indicator (VN) 186N. The frame analyzer 142 is also configured to, when a VRF usage indicator 186 has a particular value (e.g., 1, 2, or 3) indicating VRF usage, output corresponding sets of synthesis support data 150, illustrated as second synthesis support data (S2) 150B, and one or more additional sets of synthesis support data including Nth synthesis support data (SN) 150N.

The VRF generator 144 is configured to receive the sequence of VRF usage indicators and corresponding sets of synthesis support data. The VRF generator 144 is configured to selectively generate, based on the synthesis support data, one or more VRFs 156, illustrated as one or more second VRFs (R2) 156B, and one or more additional sets of VRFs including one or more Nth VRFs (RN) 156N.

The video encoder 146 is configured to generate a sequence of encoded bits 166 and a sequence of reference lists 176 corresponding to the sequence of image frames 116. The sequence of encoded bits 166 is illustrated as first encoded bits (E1) 166A, second encoded bits (E2) 166B, one or more additional sets of encoded bits including Nth encoded bits (EN) 166N. The sequence of reference lists 176 is illustrated as a first reference list (L1) 176A, a second reference list (L2) 176B, one or more additional reference lists including an Nth reference list (LN) 176N. The video encoder 146 is configured to selectively generate one or more sets of encoded bits 166 based on corresponding VRFs 156 and output the corresponding synthesis support data.

During operation, the frame analyzer 142 processes the first image frame (F1) 116A to generate the first VRF usage indicator (V1) 186A. The frame analyzer 142, in response to determining that the first VRF usage indicator (V1) 186A has a particular value (e.g., 0) indicating no VRF usage, refrains from generating corresponding synthesis support data. The VRF generator 144, in response to determining that the first VRF usage indicator (V1) 186A has a particular value (e.g., 0) indicating no VRF usage, refrains from generating any VRFs associated with the first image frame (F1) 116A. The video encoder 146, in response to determining that the first VRF usage indicator (V1) 186A has a particular value (e.g., 0) indicating no VRF usage, generates the first encoded bits (E1) 166A independently of any VRFs. The video encoder 146 outputs the first encoded bits (E1) 166A and the first reference list (L1) 176A. In a particular example, the video encoder 146 generates the first encoded bits (E1) 166A independently of any reference frames and the reference list 176A is empty. In another example, the video encoder 146 generates the first encoded bits (E1) 166A based on a previous frame of the sequence of image frames 116 and the reference list 176A indicates the previous frame.

The frame analyzer 142 processes the second image frame (F2) 116B to generate the second VRF usage indicator (V2) 186B. The frame analyzer 142, in response to determining that the second VRF usage indicator (V2) 186B has a particular value (e.g., 1, 2, or 3) indicating VRF usage, generates the second synthesis support data (S2) 150B of the second image frame (F2) 116B. The VRF generator 144, in response to determining that the second VRF usage indicator (V2) 186B has a particular value (e.g., 1, 2, or 3) indicating VRF usage, generates the one or more second VRFs (R2) 156B associated with the second image frame (F2) 116B. The video encoder 146, in response to determining that the second VRF usage indicator (V2) 186B has a particular value (e.g., 1, 2, or 3) indicating VRF usage, generates the second encoded bits (E2) 166B based on the one or more second VRFs (R2) 156B. The video encoder 146 outputs the second encoded bits (E2) 166B, the second synthesis support data (S2) 150B, and the second reference list (L2) 176B. The reference list 176B includes one or more VRF identifiers of the one or more second VRFs 156B. In some examples, the reference list 176B can also include one or more identifiers of one or more previous frames of the sequence of image frames 116 that can be used as reference frames. In some examples, the second encoded bits (E2) 166B include one or more subsets of encoded bits corresponding to one or more reference frames indicated in the reference list 176B.

Similarly, the frame analyzer 142 processes the Nth image frame (FN) 116N to generate the Nth VRF usage indicator (VN) 186N. The frame analyzer 142, in response to determining that the Nth VRF usage indicator (VN) 186N has a particular value (e.g., 1, 2, or 3) indicating VRF usage, generates the Nth synthesis support data (SN) 150N of the Nth image frame (FN) 116N. The VRF generator 144, in response to determining that the Nth VRF usage indicator (VN) 186N has a particular value (e.g., 1, 2, or 3) indicating VRF usage, generates the one or more Nth VRFs (RN) 156N associated with the Nth image frame (FN) 116N.

The video encoder 146, in response to determining that the Nth VRF usage indicator (VN) 186N has a particular value (e.g., 1, 2, or 3) indicating VRF usage, generates the Nth encoded bits (EN) 166N based on the one or more Nth VRFs (RN) 156N. The video encoder 146 outputs the Nth encoded bits (EN) 166N, the Nth synthesis support data (SN) 150N, and the Nth reference list (LN) 176N. The reference list 176N includes one or more VRF identifiers of the one or more Nth VRFs (RN) 156N. In some examples, the reference list 176B can also include one or more identifiers of one or more previous frames of the sequence of image frames 116 that can be used as reference frames. In some examples, the Nth encoded bits (EN) 166N include one or more subsets of encoded bits corresponding to one or more reference frames indicated in the reference list 176N.

By dynamically generating encoded bits based on virtual reference frames, accuracy of decoding can be improved for image frames for which synthesis support data (e.g., facial data, motion-based data, or both) can be generated.

Referring to FIG. 12, a diagram 1200 is shown of an illustrative aspect of operation of the VRF generator 244 and the video decoder 246, in accordance with some examples of the present disclosure.

The VRF generator 244 is configured to receive sets of synthesis support data and generate corresponding sets of VRFs. The sets of synthesis support data are illustrated as the second synthesis support data (S2) 150B and one or more additional sets of synthesis support data including the Nth synthesis support data (SN) 150N. The sets of VRFs are illustrated as one or more second VRFs (R2) 256B, and one or more additional sets of VRFs including one or more Nth VRFs (RN) 256N.

The video decoder 246 is configured to receive a sequence of encoded bits 166 and a sequence of reference lists 176. The sequence of encoded bits 166 is illustrated as the first encoded bits (E1) 166A, the second encoded bits (E2) 166B, and one or more additional sets of encoded bits including Nth encoded bits (EN) 166N. The sequence of reference lists 176 is illustrated as the first reference list (L1) 176A, the second reference list (L2) 176B, one or more additional reference lists including an Nth reference list (LN) 176N.

The video decoder 246 is configured to generate a sequence of decoded image frames 216 based on the sequence of encoded bits 166 and the sequence of reference lists 176. The sequence of decoded image frames 216 is illustrated as a first image frame (D1) 216A, a second image frame (D2) 216B, and one or more additional image frames including an Nth image frame (DN) 216N. The video decoder 246 is configured to selectively generate a decoded image frame based on corresponding VRFs 256.

During operation, the video decoder 246 processes the first encoded bits (E1) 166A based on the first reference list (L1) 176A to generate the first image frame (D1) 216A. The video decoder 246, in response to determining that the first reference list (L1) 176A indicates no VRFs associated with the first encoded bits (E1) 166A, generates the first image frame (D1) 216A independently of any VRFs. In a particular implementation, the video decoder 246 receives the sequence of VRF usage indicators 186. In this implementation, the video decoder 246, in response to determining that the first VRF usage indicator (V1) 186A has a particular value (e.g., 0) indicating no VRF usage, generates the first image frame (D1) 216A independently of any VRFs.

The VRF generator 244 processes the second synthesis support data (S2) 150B to generate the one or more second VRFs (R2) 256B. The video decoder 246 processes the second encoded bits (E2) 166B based on the second reference list (L2) 176B to generate the second image frame (D2) 216B. The video decoder 246, in response to determining that the second reference list (L2) 176B indicates identifiers of the one or more second VRFs (R2) 256B associated with the second encoded bits (E2) 166B, generates the second image frame (D2) 216B based on the one or more second VRFs (R2) 256B.

Similarly, the VRF generator 244 processes the Nth synthesis support data (SN) 150N to generate the one or more Nth VRFs (RN) 256N. The video decoder 246 processes the Nth encoded bits (EN) 166N based on the Nth reference list (LN) 176N to generate the Nth image frame (DN) 216N. The video decoder 246, in response to determining that the Nth reference list (LN) 176N indicates identifiers of the one or more Nth VRFs (RN) 256N associated with the Nth encoded bits (EN) 166N, generates the Nth image frame (DN) 216N based on the one or more Nth VRFs (RN) 256N.

By dynamically generating decoded image frames based on virtual reference frames, accuracy of decoding can be improved for image frames (e.g., the second image frame (D2) 216B and the Nth image frame (DN) 216N) for which synthesis support data (e.g., facial data, motion-based data, or both) is available.

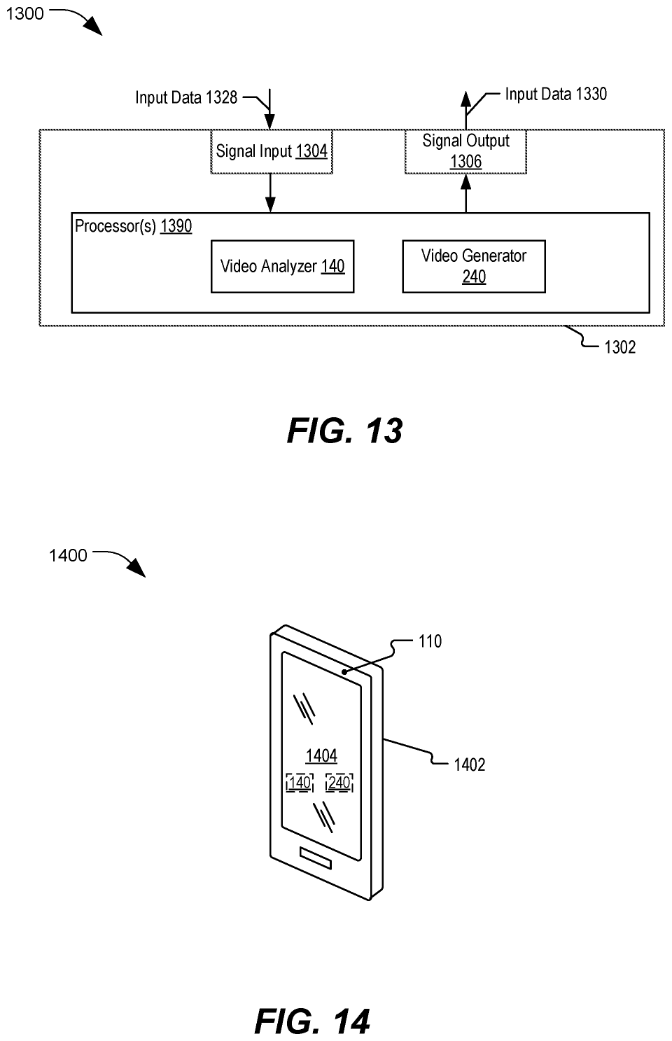

FIG. 13 depicts an implementation 1300 of the device 102 as an integrated circuit 1302 that includes one or more processors 1390. In a particular aspect, the one or more processors 1390 include the one or more processors 190, the one or more processors 290, or a combination thereof. The integrated circuit 1302 also includes a signal input 1304, such as one or more bus interfaces, to enable input data 1328 to be received for processing. The integrated circuit 1302 includes the video analyzer 140, the video generator 240, or both. The integrated circuit 1302 also includes a signal output 1306, such as a bus interface, to enable sending of output data 1330. In a particular example, the input data 1328 includes the image frames 116 and the output data 1330 includes the reference lists 176, the encoded bits 166, the VRF usage indicators 186, the synthesis support data 150, the bitstream 135, or a combination thereof. In another example, the input data 1328 includes the reference lists 176, the encoded bits 166, the VRF usage indicators 186, the synthesis support data 150, the bitstream 135, or a combination thereof, and the output data 1330 includes the image frames 216.

The integrated circuit 1302 enables implementation of image encoding and decoding based on virtual reference frames as a component in a system, such as a mobile phone or tablet as depicted in FIG. 14, a wearable electronic device as depicted in FIG. 15, a camera as depicted in FIG. 16, a virtual reality, mixed reality, or augmented reality headset as depicted in FIG. 17, or a vehicle as depicted in FIG. 18 or FIG. 19.

FIG. 14 depicts an implementation 1400 in which the device 102, the device 160, or both, includes a mobile device 1402, such as a phone or tablet, as illustrative, non-limiting examples. The mobile device 1402 includes the camera 110 and a display screen 1404. In a particular aspect, the display screen 1404 corresponds to the display device 210 of FIG. 2. Components of the one or more processors 190 and the one or more processors 290, including the video analyzer 140 and the video generator 240, are integrated in the mobile device 1402 and are illustrated using dashed lines to indicate internal components that are not generally visible to a user of the mobile device 1402. In a particular example, the video analyzer 140 operates to detect the image frames 116 or the bitstream 135, which is then processed to perform one or more operations at the mobile device 1402, such as to launch a graphical user interface or otherwise display other information at the display screen 1404 (e.g., via an integrated “smart assistant” application). For example, the display screen 1404 indicates that the image frames 116 are being processed to generate the bitstream 135 or that the bitstream 135 is being processed to generate the image frames 216.

FIG. 15 depicts an implementation 1500 in which the device 102, the device 160, or both include a wearable electronic device 1502, illustrated as a “smart watch.” The video analyzer 140, the video generator 240, the camera 110, or a combination thereof are integrated into the wearable electronic device 1502.

In a particular example, the video analyzer 140 or the video generator 240 operates to detect the image frames 116 or the bitstream 135, respectively, which is then processed to perform one or more operations at the wearable electronic device 1502, such as to launch a graphical user interface or otherwise display other information at a display screen 1504. For example, the display screen 1504 indicates that the image frames 116 are being processed to generate the bitstream 135, that the bitstream 135 is being processed to generate the image frames 216, or is used for playout of the generated image frames 216, such as in a streaming video example.

In a particular example, the wearable electronic device 1502 includes a haptic device that provides a haptic notification (e.g., vibrates) in response to detection of the image frames 116 or the bitstream 135. For example, the haptic notification can cause a user to look at the wearable electronic device 1502 to see a displayed notification indicating processing of the image frames 116 to generate the bitstream 135 that is available to transmit to another or a displayed notification indicating processing of the bitstream 135 to generate the image frames 216 that are available for viewing. The wearable electronic device 1502 can thus alert a user with a hearing impairment or a user wearing a headset that the bitstream 135 is available to transmit or that the image frames 216 are available to view.

FIG. 16 depicts an implementation 1600 in which the device 102, the device 160, or both, include a portable electronic device that corresponds to a camera device 1602. The video analyzer 140, the video generator 240, or both, are included in the camera device 1602. In a particular aspect, the camera device 1602 corresponds to or includes the camera 110 of FIG. 1. During operation, in response to receiving a verbal command identified as user speech, the camera device 1602 can execute operations responsive to spoken user commands, such as to adjust image or video capture settings, image or video playback settings, image or video capture instructions, generate the bitstream 135 based on the image frames 116, or process the bitstream 135 to display the image frames 216 at a display screen, as illustrative examples.

FIG. 17 depicts an implementation 1700 in which the device 102, the device 160, or both, include a portable electronic device that corresponds to a virtual reality, mixed reality, or augmented reality headset 1702. The video analyzer 140, the video generator 240, the camera 110, or a combination thereof, are integrated into the headset 1702. User voice activity detection can be performed based on audio signals received from a microphone of the headset 1702. A visual interface device is positioned in front of the user's eyes to enable display of augmented reality, mixed reality, or virtual reality images or scenes to the user while the headset 1702 is worn. In a particular example, the visual interface device is configured to display a notification indicating processing of the image frames 116 to generate the bitstream 135, to display a notification indicating processing of the bitstream 135 to generate the image frames 216, or is used for playout of the generated image frames 216, such as in a streaming video example.

FIG. 18 depicts an implementation 1800 in which the device 102, the device 160, or both, correspond to, or are integrated within, a vehicle 1802, illustrated as a manned or unmanned aerial device (e.g., a package delivery drone). The video analyzer 140, the video generator 240, the camera 110, or a combination thereof, are integrated into the vehicle 1802. User voice activity detection can be performed based on audio signals received from a microphone of the vehicle 1802, such as for delivery instructions from an authorized user of the vehicle 1802. In a particular example, the vehicle 1802 includes a visual interface device configured to display a notification indicating processing of the image frames 116 to generate the bitstream 135 or processing of the bitstream 135 to generate the image frames 216. In a particular aspect, the image frames 116 corresponds to images of a recipient of a package, images of assembly or installation of a delivered product, or a combination thereof. In a particular aspect, the image frames 216 correspond to assembly or installation instructions.

FIG. 19 depicts another implementation 1900 in which the device 102, the device 160, or both, corresponds to, or is integrated within, a vehicle 1902, illustrated as a car. The vehicle 1902 includes the one or more processors 1390 including the video analyzer 140, the video generator 240, or both. The vehicle 1902 also includes the camera 110. User voice activity detection can be performed based on audio signals received from a microphone of the vehicle 1902. In some implementations, user voice activity detection can be performed based on an audio signal received from interior microphones, such as for a voice command from an authorized passenger. In some implementations, user voice activity detection can be performed based on an audio signal received from external microphones, such as an authorized user of the vehicle. In a particular implementation, in response to receiving a verbal command identified as user speech, a voice activation system initiates one or more operations of the vehicle 1902 based on one or more keywords (e.g., “unlock,” “start engine,” “play music,” “display weather forecast,” “play video,” “send video,” or another voice command), such as by providing feedback or information via a display 1920 or one or more speakers. To illustrate, the display 1920 can provide information indicating that the image frames 116 have been processed to generate the bitstream 135 that is ready to transmit, that the bitstream 135 has been processed to generate the image frames 216 that are ready to display, or is used for playout of the generated image frames 216, such as in a streaming video example.

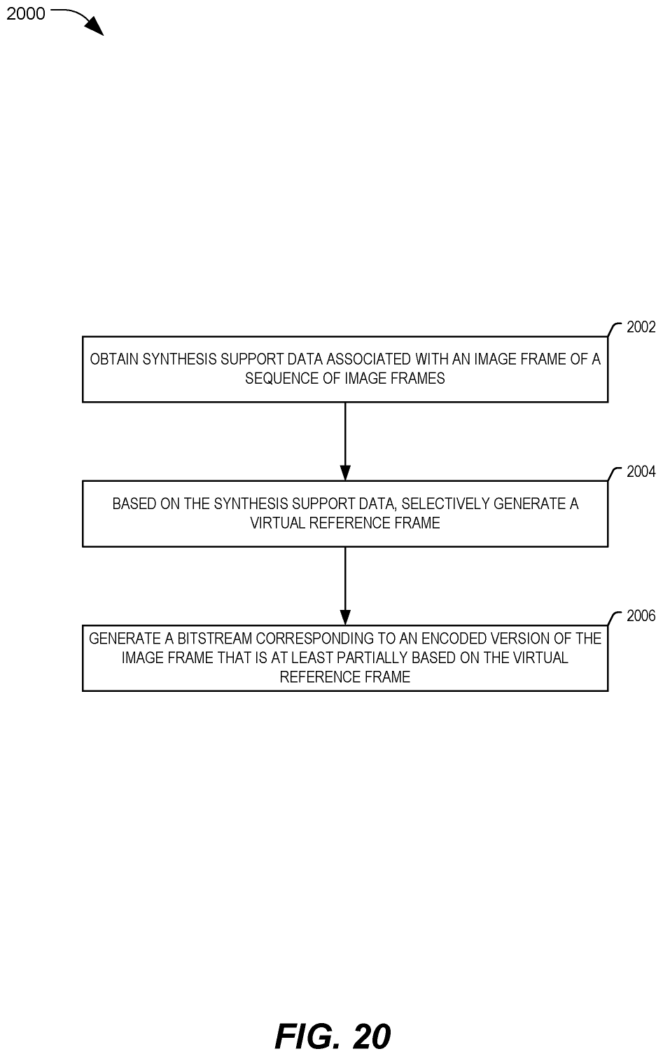

Referring to FIG. 20, a particular implementation of a method 2000 of image encoding using a virtual reference frame is shown. In a particular aspect, one or more operations of the method 2000 are performed by at least one of the frame analyzer 142, the VRF generator 144, the video encoder 146, the video analyzer 140, the one or more processors 190, the device 102, the system 100 of FIG. 1, or a combination thereof.

The method 2000 includes obtaining synthesis support data associated with an image frame of a sequence of image frames, at 2002. For example, the frame analyzer 142 of FIG. 1 obtains the synthesis support data 150N associated with the image frame 116N of the sequence of image frames 116, as described with reference to FIGS. 1 and 3.

The method 2000 also includes, based on the synthesis support data, selectively generating a virtual reference frame, at 2004. For example, the VRF generator 144 of FIG. 1, based on the synthesis support data 150N, selectively generates the one or more VRFs 156N, as described with reference to FIGS. 1 and 3-7.

The method 2000 further includes generating a bitstream corresponding to an encoded version of the image frame that is at least partially based on the virtual reference frame, at 2006. For example, the video encoder 146 of FIG. 1 generates the bitstream 135 corresponding to an encoded version of the image frame 116N that is at least partially based on the one or more VRFs 156N, as described with reference to FIGS. 1, 6, and 7.

The method 2000 thus enables generating VRFs 156 that retain perceptually important features (e.g., facial landmarks). A technical advantage of using the synthesis support data 150N (e.g., the facial landmark data, the motion-based data, or both) to generate the one or more VRFs 156N can include generating the one or more VRFs 156N that are a closer approximation of the image frame 116N thus improving video quality of decoded image frames.

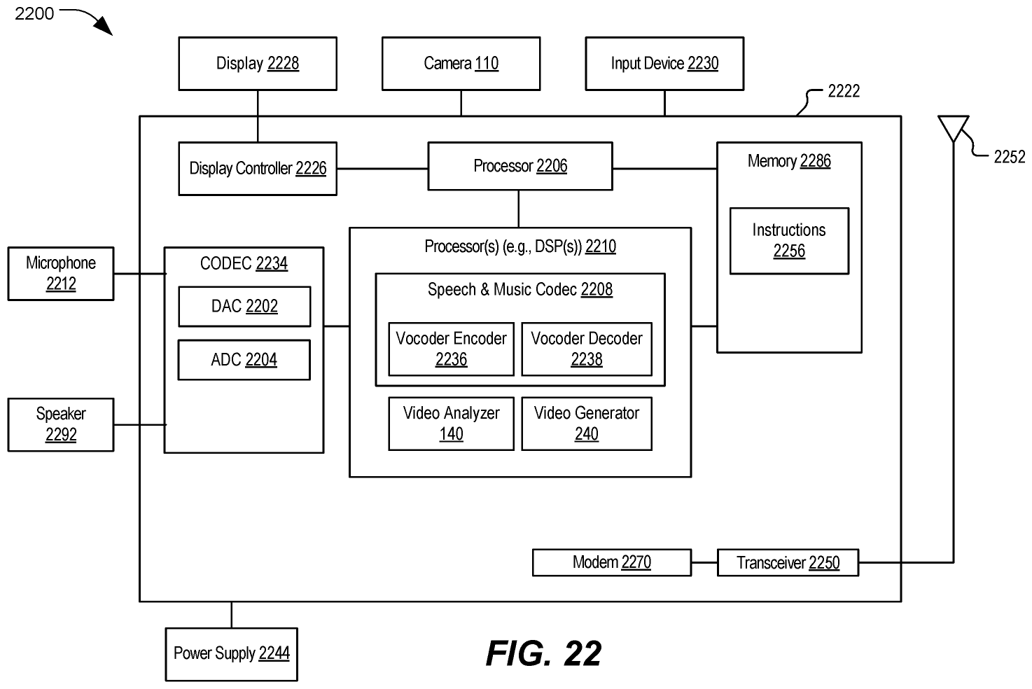

The method 2000 of FIG. 20 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 2000 of FIG. 20 may be performed by a processor that executes instructions, such as described with reference to FIG. 22.

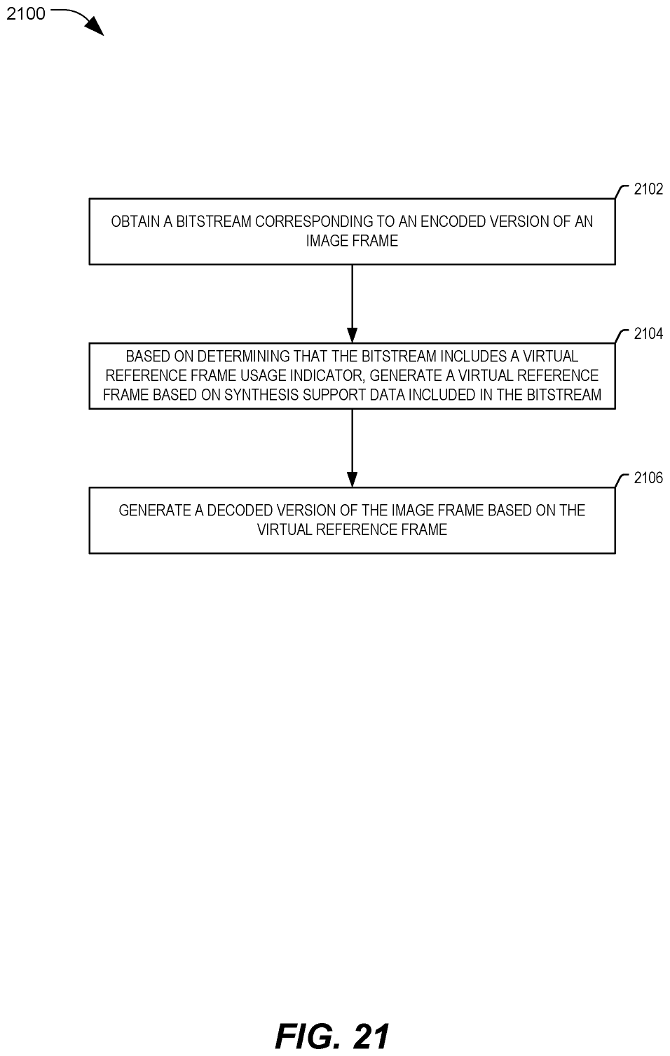

Referring to FIG. 21, a particular implementation of a method 2100 of image decoding using a virtual reference frame is shown. In a particular aspect, one or more operations of the method 2100 are performed by at least one of the device 160, the system 100 of FIG. 1, the bitstream analyzer 242, the VRF generator 244, the video decoder 246, the video generator 240, the one or more processors 290 of FIG. 2, or a combination thereof.

The method 2100 includes obtaining a bitstream corresponding to an encoded version of an image frame, at 2102. For example, the bitstream analyzer 242 of FIG. 2 obtains the bitstream 135 corresponding to an encoded version of the image frame 116N, as described with reference to FIG. 2.

The method 2100 also includes, based on determining that the bitstream includes a virtual reference frame usage indicator, generating a virtual reference frame based on synthesis support data included in the bitstream, at 2104. For example, the VRF generator 244 of FIG. 2, in response to determining that the bitstream 135 includes a VRF usage indicator 186N having a particular value (e.g., 1, 2, or 3) indicating VRF usage, generates the one or more VRFs 256N based on the synthesis support data 150N included in the bitstream 135, as described with reference to FIG. 2.

The method 2100 further includes generating a decoded version of the image frame based on the virtual reference frame, at 2106. For example, the video decoder 246 of FIG. 2 generates the image frame 216N (e.g., a decoded version of the image frame 116N) based on the one or more VRFs 256N, as described with reference to FIG. 2.

The method 2100 thus enables using VRFs 256 that retain perceptually important features (e.g., facial landmarks) to generate decoded image frames (e.g., the image frame 216N). A technical advantage of using the synthesis support data 150N (e.g., the facial landmark data, the motion-based data, or both) to generate the one or more VRFs 256N can including using the one or more VRFs 256N that are a closer approximation of the image frame 116N thus improving video quality of the image frame 216N.

The method 2100 of FIG. 21 may be implemented by a FPGA device, an ASIC, a processing unit such as a CPU, a DSP, a controller, another hardware device, firmware device, or any combination thereof. As an example, the method 2100 of FIG. 21 may be performed by a processor that executes instructions, such as described with reference to FIG. 22.

Referring to FIG. 22, a block diagram of a particular illustrative implementation of a device is depicted and generally designated 2200. In various implementations, the device 2200 may have more or fewer components than illustrated in FIG. 22. In an illustrative implementation, the device 2200 may correspond to the device 102, the device 160 of FIG. 1, or both. In an illustrative implementation, the device 2200 may perform one or more operations described with reference to FIGS. 1-21.

In a particular implementation, the device 2200 includes a processor 2206 (e.g., a CPU). The device 2200 may include one or more additional processors 2210 (e.g., one or more DSPs). In a particular aspect, the one or more processors 190 of FIG. 1 correspond to the processor 2206, the processors 2210, or a combination thereof. In a particular aspect, the one or more processors 290 of FIG. 2 correspond to the processor 2206, the processors 2210, or a combination thereof. The processors 2210 may include a speech and music coder-decoder (CODEC) 2208 that includes a voice coder (“vocoder”) encoder 2236, a vocoder decoder 2238, or both. The processors 2210 may include the video analyzer 140, the video generator 240, or both.

The device 2200 may include a memory 2286 and a CODEC 2234. The memory 2286 may include instructions 2256, that are executable by the one or more additional processors 2210 (or the processor 2206) to implement the functionality described with reference to the video analyzer 140, the video generator 240, or both. The device 2200 may include a modem 2270 coupled, via a transceiver 2250, to an antenna 2252. In a particular aspect, the modem 2270 includes the modem 170 of FIG. 1, the modem 270 of FIG. 2, or both.

The device 2200 may include a display 2228 coupled to a display controller 2226. In a particular aspect, the display 2228 includes the display device 210 of FIG. 2. A speaker 2292, a microphone 2212, the camera 110, or a combination thereof, may be coupled to the CODEC 2234. The CODEC 2234 may include a digital-to-analog converter (DAC) 2202, an analog-to-digital converter (ADC) 2204, or both. In a particular implementation, the CODEC 2234 may receive analog signals from the microphone 2212, convert the analog signals to digital signals using the analog-to-digital converter 2204, and provide the digital signals to the speech and music codec 2208. The speech and music codec 2208 may process the digital signals. In a particular implementation, the speech and music codec 2208 may provide digital signals to the CODEC 2234. The CODEC 2234 may convert the digital signals to analog signals using the digital-to-analog converter 2202 and may provide the analog signals to the speaker 2292.

In a particular implementation, the device 2200 may be included in a system-in-package or system-on-chip device 2222. In a particular implementation, the memory 2286, the processor 2206, the processors 2210, the display controller 2226, the CODEC 2234, and the modem 2270 are included in the system-in-package or system-on-chip device 2222. In a particular implementation, an input device 2230 and a power supply 2244 are coupled to the system-in-package or the system-on-chip device 2222.

Moreover, in a particular implementation, as illustrated in FIG. 22, the display 2228, the camera 110, the input device 2230, the speaker 2292, the microphone 2212, the antenna 2252, and the power supply 2244 are external to the system-in-package or the system-on-chip device 2222. In a particular implementation, each of the display 2228, the camera 110, the input device 2230, the speaker 2292, the microphone 2212, the antenna 2252, and the power supply 2244 may be coupled to a component of the system-in-package or the system-on-chip device 2222, such as an interface or a controller.

The device 2200 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining synthesis support data associated with an image frame of a sequence of image frames. For example, the means for obtaining the synthesis support data can correspond to the frame analyzer 142, the video analyzer 140, the modem 170, the one or more processors 190, the device 102, the system 100 of FIG. 1, the face detector 302, the facial landmark detector 304, the global motion detector 306, the visual analytics engine 312 of FIG. 3, the modem 2270, the transceiver 2250, the antenna 2252, the processor 2206, the processors 2210, the device 2200, one or more other circuits or components configured to obtain synthesis support data, or any combination thereof.

The apparatus also includes means for selectively generating a virtual reference frame based on the synthesis support data. For example, the means for selectively generating the virtual reference frame can correspond to the VRF generator 144, the video analyzer 140, the one or more processors 190, the device 102, the system 100 of FIG. 1, the facial VRF generator 504, the motion VRF generator 506 of FIG. 5, the processor 2206, the processors 2210, the device 2200, one or more other circuits or components configured to selectively generate a virtual reference frame, or any combination thereof.

The apparatus further includes means for generating a bitstream corresponding to an encoded version of the image frame that is at least partially based on the virtual reference frame. For example, the means for generating the bitstream can correspond to the video encoder 146, the video analyzer 140, the modem 170, the one or more processors 190, the device 102, the system 100 of FIG. 1, the modem 2270, the transceiver 2250, the antenna 2252, the processor 2206, the processors 2210, the device 2200, one or more other circuits or components configured to generate the bitstream, or any combination thereof.

Also in conjunction with the described implementations, an apparatus includes means for obtaining a bitstream corresponding to an encoded version of an image frame. For example, the means for obtaining the bitstream can correspond to the device 160, the system 100, the modem 270, the bitstream analyzer 242, the video generator 240, the one or more processors 290 of FIG. 2, the modem 2270, the transceiver 2250, the antenna 2252, the processor 2206, the processors 2210, the device 2200, one or more other circuits or components configured to obtain the bitstream, or any combination thereof.

The apparatus also includes means for generating a virtual reference frame based on synthesis support data included in the bitstream, the virtual reference frame generated based on determining that the bitstream includes a virtual reference frame usage indicator. For example, the means for generating the virtual reference frame can correspond to the device 160, the system 100 of FIG. 1, the VRF generator 244, the video generator 240, the one or more processors 290 of FIG. 2, the processor 2206, the processors 2210, the device 2200, one or more other circuits or components configured to generate the virtual reference frame, or any combination thereof.

The apparatus further includes means for generating a decoded version of the image frame based on the virtual reference frame. For example, the means for generating the virtual reference frame can correspond to the device 160, the system 100 of FIG. 1, the VRF generator 244, the video generator 240, the one or more processors 290 of FIG. 2, the processor 2206, the processors 2210, the device 2200, one or more other circuits or components configured to generate the virtual reference frame, or any combination thereof.

In some implementations, a non-transitory computer-readable medium (e.g., a computer-readable storage device, such as the memory 2286) includes instructions (e.g., the instructions 2256) that, when executed by one or more processors (e.g., the one or more processors 190, the one or more processors 2210, or the processor 2206), cause the one or more processors to obtain synthesis support data (e.g., the synthesis support data 150N) associated with an image frame (e.g., the image frame 116N) of a sequence of image frames (e.g., the image frames 116). The instructions, when executed by the one or more processors, also cause the one or more processors to selectively generate a virtual reference frame (e.g., the one or more VRFs 156N) based on the synthesis support data. The instructions, when executed by the one or more processors, further cause the one or more processors to generate a bitstream (e.g., the bitstream 135) corresponding to an encoded version of the image frame that is at least partially based on the virtual reference frame.

In some implementations, a non-transitory computer-readable medium (e.g., a computer-readable storage device, such as the memory 2286) includes instructions (e.g., the instructions 2256) that, when executed by one or more processors (e.g., the one or more processors 290, the one or more processors 2210, or the processor 2206), cause the one or more processors to obtain a bitstream (e.g., the bitstream 135) corresponding to an encoded version of an image frame (e.g., the image frame 116N). The instructions, when executed by the one or more processors, also cause the one or more processors to, based on determining that the bitstream includes a virtual reference frame usage indicator (e.g., the VRF usage indicator 186N), generate a virtual reference frame (e.g., the one or more VRFs 256N) based on synthesis support data (e.g., the synthesis support data 150N) included in the bitstream. The instructions, when executed by the one or more processors, further cause the one or more processors to generate a decoded version of the image frame based on the virtual reference frame.

Particular aspects of the disclosure are described below in sets of interrelated Examples:

According to Example 1, a device includes: one or more processors configured to: obtain a bitstream corresponding to an encoded version of an image frame; based on determining that the bitstream includes a virtual reference frame usage indicator, generate a virtual reference frame based on synthesis support data included in the bitstream; and generate a decoded version of the image frame based on the virtual reference frame.

Example 2 includes the device of Example 1, wherein the synthesis support data includes facial landmark data, motion-based data, or a combination thereof.

Example 3 includes the device of Example 1 or Example 2, wherein the bitstream indicates a first set of reference candidates that includes the virtual reference frame.

Example 4 includes the device of Example 3, wherein the bitstream indicates one or more additional first sets of reference candidates that include one or more additional virtual reference frames associated with one or more additional image frames of a sequence of image frames.

Example 5 includes the device of any of Example 1 to Example 4, wherein the bitstream further indicates a second set of reference candidates including one or more previously decoded image frames.

Example 6 includes the device of any of Example 1 to Example 5, wherein the bitstream includes a supplemental enhancement information (SEI) message indicating the synthesis support data.

Example 7 includes the device of any of Example 1 to Example 6, wherein the synthesis support data includes facial landmark data indicating locations of facial features, and wherein the one or more processors are configured to generate the virtual reference frame based at least in part on a previously decoded image frame and the locations of facial features.

Example 8 includes the device of any of Example 1 to Example 7, wherein the synthesis support data includes motion-based data indicating global motion, and wherein the one or more processors are configured to generate the virtual reference frame based at least in part on a previously decoded image frame and the global motion.

Example 9 includes the device of any of Example 1 to Example 8, wherein the one or more processors are configured to use motion-based data to warp a previously decoded image frame to generate the virtual reference frame, wherein the synthesis support data includes the motion-based data.

Example 10 includes the device of any of Example 1 to Example 9, wherein the one or more processors are configured to use a trained model to generate the virtual reference frame.

Example 11 includes the device of Example 10, wherein the trained model includes a neural network.

Example 12 includes the device of Example 10 or Example 11, wherein an input to the trained model includes the synthesis support data and at least one previously decoded image frame.

Example 13 includes the device of any of Example 1 to Example 12, further including a modem configured to receive the bitstream from a second device.

Example 14 includes the device of any of Example 1 to Example 13, further including a display device configured to display the decoded version of the image frame.

According to Example 15, a method includes: obtaining, at a device, a bitstream corresponding to an encoded version of an image frame; based on determining that the bitstream includes a virtual reference frame usage indicator, generating a virtual reference frame based on synthesis support data included in the bitstream; and generating, at the device, a decoded version of the image frame based on the virtual reference frame.

Example 16 includes the method of Example 15, wherein the synthesis support data includes facial landmark data, motion-based data, or a combination thereof.

Example 17 includes the method of Example 15 or Example 16, wherein the bitstream indicates a first set of reference candidates that includes the virtual reference frame.

Example 18 includes the method of Example 17, wherein the bitstream indicates one or more additional first sets of reference candidates that include one or more additional virtual reference frames associated with one or more additional image frames of a sequence of image frames.

Example 19 includes the method of any of Example 15 to Example 18, wherein the bitstream further indicates a second set of reference candidates including one or more previously decoded image frames.

Example 20 includes the method of any of Example 15 to Example 19, wherein the bitstream includes a supplemental enhancement information (SEI) message indicating the synthesis support data.

Example 21 includes the method of any of Example 15 to Example 20, further including generating the virtual reference frame based at least in part on a previously decoded image frame and locations of facial features, wherein the synthesis support data includes facial landmark data indicating the locations of facial features.

Example 22 includes the method of any of Example 15 to Example 21, further including generating the virtual reference frame based at least in part on a previously decoded image frame and global motion, wherein the synthesis support data includes motion-based data indicating the global motion.

Example 23 includes the method of any of Example 15 to Example 22, further including using motion-based data to warp a previously decoded image frame to generate the virtual reference frame, wherein the synthesis support data includes the motion-based data.

Example 24 includes the method of any of Example 15 to Example 23, further including using a trained model to generate the virtual reference frame.

Example 25 includes the method of Example 24, wherein the trained model includes a neural network.

Example 26 includes the method of Example 24 or Example 25, wherein an input to the trained model includes the synthesis support data and at least one previously decoded image frame.

Example 27 includes the method of any of Example 15 to Example 26, further including receiving the bitstream via a modem from a second device.

Example 28 includes the method of any of Example 15 to Example 27, further including displaying the decoded version of the image frame at a display device.

According to Example 29, a device includes: a memory configured to store instructions; and a processor configured to execute the instructions to perform the method of any of Example 15 to 28.

According to Example 30, a non-transitory computer-readable medium stores instructions that, when executed by a processor, cause the processor to perform the method of any of Example 15 to Example 28.

According to Example 31, an apparatus includes means for carrying out the method of any of Example 15 to Example 28.

According to Example 32, a non-transitory computer-readable medium stores instructions that, when executed by one or more processors, cause the one or more processors to: obtain a bitstream corresponding to an encoded version of an image frame; based on determining that the bitstream includes a virtual reference frame usage indicator, generate a virtual reference frame based on synthesis support data included in the bitstream; and generate a decoded version of the image frame based on the virtual reference frame.

According to Example 33, an apparatus includes: means for obtaining a bitstream corresponding to an encoded version of an image frame; means for generating a virtual reference frame based on synthesis support data included in the bitstream, the virtual reference frame generated based on determining that the bitstream includes a virtual reference frame usage indicator; and means for generating a decoded version of the image frame based on the virtual reference frame.

According to Example 34, a device includes: one or more processors configured to: obtain synthesis support data associated with an image frame of a sequence of image frames; selectively generate a virtual reference frame based on the synthesis support data; and generate a bitstream corresponding to an encoded version of the image frame that is at least partially based on the virtual reference frame.

Example 35 includes the device of Example 34, wherein the synthesis support data includes facial landmark data, motion-based data, or a combination thereof.

Example 36 includes the device of Example 34 or Example 35, wherein the bitstream includes the synthesis support data.

Example 37 includes the device of any of Example 34 to Example 36, wherein the one or more processors are configured to generate a first set of reference candidates that includes the virtual reference frame.

Example 38 includes the device of Example 37, wherein the bitstream indicates the first set of reference candidates.

Example 39 includes the device of Example 37 or Example 38, wherein the one or more processors are configured to generate one or more additional first sets of reference candidates that include one or more additional virtual reference frames associated with one or more additional image frames of the sequence of image frames.

Example 40 includes the device of any of Example 34 to Example 39, wherein the bitstream further indicates a second set of reference candidates including one or more previously decoded image frames.

Example 41 includes the device of Example 40, wherein the one or more processors are configured to generate the virtual reference frame based at least in part on determining that a count of reference frames in the second set of reference candidates is less than a threshold reference count of a coding configuration.

Example 42 includes the device of any of Example 34 to Example 41, wherein the one or more processors are configured to, based at least in part on detecting a face in the image frame, generate the virtual reference frame.

Example 43 includes the device of any of Example 34 to Example 42, wherein the one or more processors are configured to: obtain motion-based data associated with the image frame; and based at least in part on determining that the motion-based data indicates global motion that is greater than a global motion threshold, generate the virtual reference frame.

Example 44 includes the device of any of Example 34 to Example 43, wherein the bitstream includes a supplemental enhancement information (SEI) message indicating the synthesis support data.

Example 45 includes the device of any of Example 34 to Example 44, wherein the synthesis support data includes facial landmark data that indicates locations of facial features in the image frame.

Example 46 includes the device of Example 45, wherein the facial features include at least one of an eye, an eyelid, an eyebrow, a nose, lips, or a facial outline.

Example 47 includes the device of any of Example 34 to Example 46, wherein the synthesis support data includes motion sensor data indicating motion of an image capture device associated with the image frame.

Example 48 includes the device of Example 47, wherein the image capture device includes at least one of an extended reality (XR) device, a vehicle, or a camera.

Example 49 includes the device of any of Example 34 to Example 48, wherein the one or more processors are configured to use motion-based data to warp a previously decoded image frame to generate the virtual reference frame, wherein the synthesis support data includes the motion-based data.

Example 50 includes the device of any of Example 34 to Example 49, wherein the bitstream includes a supplemental enhancement information (SEI) message indicating virtual reference frame usage to generate a decoded version of the image frame.

Example 51 includes the device of any of Example 34 to Example 50, wherein the one or more processors are configured to use a trained model to generate the virtual reference frame.

Example 52 includes the device of Example 51, wherein the trained model includes a neural network.

Example 53 includes the device of Example 51 or Example 52, wherein input to the trained model includes the synthesis support data and at least one previously decoded image frame.

Example 54 includes the device of any of Example 34 to Example 53, further including a modem configured to transmit the bitstream to a second device.

Example 55 includes the device of any of Example 34 to Example 54, further including a camera configured to capture the image frame.

According to Example 56, a method includes: obtaining, at a device, synthesis support data associated with an image frame of a sequence of image frames; selectively generating a virtual reference frame based on the synthesis support data; and generating, at the device, a bitstream corresponding to an encoded version of the image frame that is at least partially based on the virtual reference frame.

Example 57 includes the method of Example 56, wherein the synthesis support data includes facial landmark data, motion-based data, or a combination thereof.

Example 58 includes the method of Example 56 or Example 57, wherein the bitstream includes the synthesis support data.

Example 59 includes the method of any of Example 56 to Example 58, further including generating a first set of reference candidates that includes the virtual reference frame.

Example 60 includes the method of Example 59, wherein the bitstream indicates the first set of reference candidates.

Example 61 includes the method of Example 59 or Example 60, further including generating one or more additional first sets of reference candidates that include one or more additional virtual reference frames associated with one or more additional image frames of the sequence of image frames.

Example 62 includes the method of any of Example 56 to Example 61, wherein the bitstream further indicates a second set of reference candidates including one or more previously decoded image frames.

Example 63 includes the method of Example 62, further including generating the virtual reference frame based at least in part on determining that a count of reference frames in the second set of reference candidates is less than a threshold reference count of a coding configuration.

Example 64 includes the method of any of Example 56 to Example 63, further including, based at least in part on detecting a face in the image frame, generating the virtual reference frame.

Example 65 includes the method of any of Example 56 to Example 64, further including: obtaining motion-based data associated with the image frame; and based at least in part on determining that the motion-based data indicates global motion that is greater than a global motion threshold, generating the virtual reference frame.

Example 66 includes the method of any of Example 56 to Example 65, wherein the bitstream includes a supplemental enhancement information (SEI) message indicating the synthesis support data.

Example 67 includes the method of any of Example 56 to Example 66, wherein the synthesis support data includes facial landmark data that indicates locations of facial features in the image frame.

Example 68 includes the method of Example 67, wherein the facial features include at least one of an eye, an eyelid, an eyebrow, a nose, lips, or a facial outline.

Example 69 includes the method of any of Example 56 to Example 68, wherein the synthesis support data includes motion sensor data indicating motion of an image capture device associated with the image frame.

Example 70 includes the method of Example 69, wherein the image capture device includes at least one of an extended reality (XR) device, a vehicle, or a camera.

Example 71 includes the method of any of Example 56 to Example 70, further including using motion-based data to warp a previously decoded image frame to generate the virtual reference frame, wherein the synthesis support data includes the motion-based data.

Example 72 includes the method of any of Example 56 to Example 71, wherein the bitstream includes a supplemental enhancement information (SEI) message indicating virtual reference frame usage to generate a decoded version of the image frame.

Example 73 includes the method of any of Example 56 to Example 72, further including using a trained model to generate the virtual reference frame.

Example 74 includes the method of Example 73, wherein the trained model includes a neural network.

Example 75 includes the method of Example 73 or Example 74, wherein input to the trained model includes the synthesis support data and at least one previously decoded image frame.

Example 76 includes the method of any of Example 56 to Example 75, further including transmitting the bitstream via a modem to a second device.

Example 77 includes the method of any of Example 56 to Example 76, further including receiving the image frame from a camera.

According to Example 78, a device includes: a memory configured to store instructions; and a processor configured to execute the instructions to perform the method of any of Example 56 to 77.

According to Example 79, a non-transitory computer-readable medium stores instructions that, when executed by a processor, cause the processor to perform the method of any of Example 56 to Example 77.

According to Example 80, an apparatus includes means for carrying out the method of any of Example 56 to Example 77.

According to Example 81, a non-transitory computer-readable medium stores instructions that, when executed by one or more processors, cause the one or more processors to: obtain synthesis support data associated with an image frame of a sequence of image frames; selectively generate a virtual reference frame based on the synthesis support data; and generate a bitstream corresponding to an encoded version of the image frame that is at least partially based on the virtual reference frame.

According to Example 82, an apparatus includes: means for obtaining synthesis support data associated with an image frame of a sequence of image frames; means for selectively generating a virtual reference frame based on the synthesis support data; and means for generating a bitstream corresponding to an encoded version of the image frame that is at least partially based on the virtual reference frame.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain a bitstream corresponding to an encoded version of an image frame;
based on determining that the bitstream includes a virtual reference frame usage indicator, generate a virtual reference frame based on synthesis support data included in the bitstream; and
generate a decoded version of the image frame based on the virtual reference frame.

2. The device of claim 1, wherein the synthesis support data includes facial landmark data, motion-based data, or a combination thereof.

3. The device of claim 1, wherein the bitstream indicates a first set of reference candidates that includes the virtual reference frame.

4. The device of claim 3, wherein the bitstream indicates one or more additional first sets of reference candidates that include one or more additional virtual reference frames associated with one or more additional image frames of a sequence of image frames.

5. The device of claim 1, wherein the bitstream further indicates a second set of reference candidates including one or more previously decoded image frames.

6. The device of claim 1, wherein the bitstream includes a supplemental enhancement information (SEI) message indicating the synthesis support data.

7. The device of claim 1, wherein the synthesis support data includes facial landmark data indicating locations of facial features, and wherein the one or more processors are configured to generate the virtual reference frame based at least in part on a previously decoded image frame and the locations of facial features.

8. The device of claim 1, wherein the synthesis support data includes motion-based data indicating global motion, and wherein the one or more processors are configured to generate the virtual reference frame based at least in part on a previously decoded image frame and the global motion.

9. The device of claim 1, wherein the one or more processors are configured to use motion-based data to warp a previously decoded image frame to generate the virtual reference frame, wherein the synthesis support data includes the motion-based data.

10. The device of claim 1, wherein the one or more processors are configured to use a trained model to generate the virtual reference frame, and wherein an input to the trained model includes the synthesis support data and at least one previously decoded image frame.

11. The device of claim 1, further comprising a modem configured to receive the bitstream from a second device.

12. The device of claim 1, further comprising a display device configured to display the decoded version of the image frame.

13. A method comprising:
obtaining, at a device, a bitstream corresponding to an encoded version of an image frame;
based on determining that the bitstream includes a virtual reference frame usage indicator, generating a virtual reference frame based on synthesis support data included in the bitstream; and
generating, at the device, a decoded version of the image frame based on the virtual reference frame.

14. A device comprising:
one or more processors configured to:
obtain synthesis support data associated with an image frame of a sequence of image frames;
selectively generate a virtual reference frame based on the synthesis support data; and
generate a bitstream corresponding to an encoded version of the image frame that is at least partially based on the virtual reference frame.

15. The device of claim 14, wherein the synthesis support data includes facial landmark data, motion-based data, or a combination thereof.

16. The device of claim 14, wherein the bitstream includes the synthesis support data.

17. The device of claim 14, wherein the one or more processors are configured to generate a first set of reference candidates that includes the virtual reference frame.

18. The device of claim 17, wherein the bitstream indicates the first set of reference candidates.

19. The device of claim 17, wherein the one or more processors are configured to generate one or more additional first sets of reference candidates that include one or more additional virtual reference frames associated with one or more additional image frames of the sequence of image frames.

20. The device of claim 14, wherein the bitstream further indicates a second set of reference candidates including one or more previously decoded image frames, and wherein the one or more processors are configured to generate the virtual reference frame based at least in part on determining that a count of reference frames in the second set of reference candidates is less than a threshold reference count of a coding configuration.

21. The device of claim 14, wherein the one or more processors are configured to, based at least in part on detecting a face in the image frame, generate the virtual reference frame.

22. The device of claim 14, wherein the one or more processors are configured to:
obtain motion-based data associated with the image frame; and
based at least in part on determining that the motion-based data indicates global motion that is greater than a global motion threshold, generate the virtual reference frame.

23. The device of claim 14, wherein the synthesis support data includes facial landmark data that indicates locations of facial features in the image frame.

24. The device of claim 14, wherein the synthesis support data includes motion sensor data indicating motion of an image capture device associated with the image frame.

25. The device of claim 24, wherein the image capture device includes at least one of an extended reality (XR) device, a vehicle, or a camera.

26. The device of claim 14, wherein the one or more processors are configured to use motion-based data to warp a previously decoded image frame to generate the virtual reference frame, wherein the synthesis support data includes the motion-based data.

27. The device of claim 14, wherein the bitstream includes a supplemental enhancement information (SEI) message indicating virtual reference frame usage to generate a decoded version of the image frame.

28. The device of claim 14, wherein the one or more processors are configured to use a trained model to generate the virtual reference frame, and wherein input to the trained model includes the synthesis support data and at least one previously decoded image frame.

29. The device of claim 14, further comprising a modem configured to transmit the bitstream to a second device.

30. A method comprising:
obtaining, at a device, synthesis support data associated with an image frame of a sequence of image frames;
selectively generating a virtual reference frame based on the synthesis support data; and
generating, at the device, a bitstream corresponding to an encoded version of the image frame that is at least partially based on the virtual reference frame.
